(19) United States
(12) Patent Application Publication
(10) Pub. No.: US 2016/0017206 A1
(43) Pub. Date: Jan. 21, 2016

(54) METHODS FOR IMMEDIATE SOURING CONTROL IN GASES OR FLUIDS PRODUCED FROM SULFIDOGENIC RESERVOIR SYSTEMS

(71) Applicant: THE REGENTS OF THE UNIVERSITY OF CALIFORNIA, Oakland, CA (US)

(72) Inventor: John D. COATES, Walnut Creek, CA (US)

(73) Assignee: The Regents of the University of California, Oakland, CA (US)

(21) Appl. No.: 14/771,476

(22) PCT Filed: Feb. 21, 2014
(86) PCT No.: PCT/US2014/017830

§ 371 Date: Aug. 28, 2015

Related U.S. Application Data
(60) Provisional application No. 61/771,757, filed on Mar. 1, 2013.

(51) Int. Cl. C09K 8/532; E21B 41/00

(52) U.S. Cl. CPC C09K 8/532; E21B 41/00

(57) ABSTRACT

The present disclosure relates to methods of controlling the sulfide (S²⁻) content in gases or fluids produced from sulfidogenic reservoir systems, such as oil reservoirs, by inducing authigenic mineral-precipitating bacteria to precipitate sulfide-scavenging authigenic rock material in the production well environment.

### CROSS-REFERENCE TO RELATED APPLICATION

This application claims the benefit of U.S. Provisional patent application Ser. No. 61/771,757, filed Mar. 1, 2013, which is hereby incorporated by reference, in its entirety.

### BACKGROUND

1. Field

The present disclosure relates generally to methods for controlling the sulfide (S²⁻) contents in fluids (gases or liquids) produced from sulfidogenic reservoir systems and, more specifically, to methods for controlling reservoir souring at the production well.

2. Description of Related Art

Hydrogen sulfide (H₂S) is toxic, corrosive, and emits highly noxious odors. Consequently, hydrogen sulfide is considered an undesirable contaminant in many industrial products, including industrial gases and engine fuels. Moreover, hydrogen sulfide can cause problems during the recovery of oil or natural gas from sulfidogenic reservoirs. In oil fields, hydrogen sulfide can pose health hazards to workers and cause damage to drilling equipment, thereby resulting in significant production delays and replacement costs. Especially at the production wells hydrogen sulfide can promote metal corrosion and the precipitation of metal sulfides that can plug pumping wells.

In many cases, the sulfide content of production fluids increases substantially with the initiation of secondary oil recovery processes. This phenomenon is called reservoir souring. Today reservoir souring is generally accepted to primarily be of microbial origin. Secondary oil recovery involves the injection of water into the oil reservoir and a water sweep across the reservoir starting at the injection well and driving out crude oil, water, and gas at the production well (FIG. 1A). The water used for secondary oil recovery, such as sea-water, is often rich in sulfates. These sulfates can subsequently be converted to sulfides by Sulfate Reducing Bacteria (SRB) that are indigenous in seawater and in many reservoir systems.

Thus, effective methods are needed to remove sulfides from fluids produced from sulfidogenic reservoirs, especially during the secondary production phase. Both chemical and microbial methods have been considered.

Chemical methods for removing sulfides typically involve the reaction of production fluids with metal sorbents or metal chelates to form insoluble metal sulfides. The metal sorbents are commonly made of iron oxides, zinc oxides, or zinc aluminates and produced in a particulate form (see, e.g., U.S. Pat. No. 4,956,160; U.S. Pat. Pub. No. 2008/0251423). In some applications the metal sorbent particles are added to drilling fluids at the bore holes during the oil recovery phase. In other applications the particles are added to feedstocks, e.g., as part of a refining process.

The sorbent particles' ability to extract sulfides from crude oil is highly dependent on their exact chemical and physical composition, including particle size, and porosity. Consequently, the production of well-defined and effective metal sorbent particles is relatively complex, labor-intensive, and costly. Moreover, many types of sorbent particles have to be applied either in large quantities or they require long contact times with production fluids, especially in the typically alkaline environment of drilling fluids. The use of metal chelates, such as iron-EDTA chelates, as sulfide scavengers in drilling fluids has also been reported. However, such chelates are costly and of limited stability under downhole conditions. Thus, there exists a need to develop a more economical and efficient method for chemically removing sulfides from production fluids.

Microbial processes for controlling reservoir souring, e.g., by inhibiting microbial sulfide production or by promoting microbial sulfide turnover, have been considered as one aspect of microbial enhanced-hydrocarbon recovery (MEHR, see, e.g., FIGS. 2 and 3). But even though the role of SRBs in promoting reservoir souring is generally accepted today, an understanding of the underlying microbial metabolism and its regulation is only beginning to emerge. Moreover, control of reservoir souring through MEHR requires the injection of SRB inhibitors at the injection well. Thus there is a lag in the onset of measurable effect as the gradual physical removal and metabolic turnover of sulfides contained in the entire sulfidogenic reservoir, and especially of sulfides produced near the injection well upon initiation of the water sweep during secondary oil recovery. Consequently, injection well processes targeting inhibition of SRB in situ are expected to result only in a delayed and gradual decline of sulfide content in produced fluids emerging at the production well, with a time frame ultimately determined by the effectiveness of the inhibitor, the dilution rate, and the hydraulic residence time between the injection and production wells.

Thus, there exists a need to develop an economic and effective method for lowering the sulfide (S²⁻) content in production fluids and gases at the production well.

### BRIEF SUMMARY

In order to meet the above needs, the present disclosure provides methods for decreasing one or more sulfide containing compounds in a gas or fluid produced from a sulfidogenic reservoir system, by providing an authigenic mineral precursor solution and an authigenic mineral-precipitation inducer, and adding the precursor and inducer to the production well environment of the system, whereby the production well environment contains authigenic mineral precipitating bacteria, a rock matrix and a gas or fluid, and whereby the precursor and inducer are added to the production well environment under conditions whereby the inducer induces the bacteria to precipitate a authigenic mineral from the solution into the rock matrix and whereby the precipitated authigenic mineral scavenges one or more sulfide containing compounds from the gas or fluid in the production well environment (FIG. 1B). Advantageously, the methods of the present disclosure utilize authigenic mineral-precipitating bacteria that are ubiquitous and active in the disclosed systems, such as oil reservoirs and their production well environments. Moreover, the methods of the present disclosure advantageously utilize the reversibility of the bacterial-mediated authigenic rock mineral precipitation to regenerate the sulfide-scavenging capacity of the production well environment by dissolving the precipitated authigenic mineral by reversing the authigenic mineral precipitation reaction and thereby releasing the previously scavenged sulfide-containing compounds from the rock matrix into the gas or fluid in the production well environment and by subsequently removing the released compounds from the sulfidogenic reservoir along with the gas or fluid in the production well environment. Moreover, the methods of the present disclosure can advantageously be combined with additional methods for preparing rock matrices in the production well environment for the authigenic mineral precipitation by increasing the porosity and surface areas of the rock matrices by mechanical, chemical, or biological means, such as induced hydrofracturing or biological weathering. Moreover, the methods of the present disclosure can advantageously be combined with additional methods for decreasing the amount of one or more sulfide-containing compounds in sulfidogenic reservoir systems by stimulating (per)chlorate-reducing bacteria or by inhibiting sulfate-reducing bacteria.

Accordingly, certain aspects of the present disclosure relate to a method of decreasing one or more sulfide containing compounds in a gas or fluid produced from a sulfidogenic reservoir system, by: a) providing a sulfidogenic reservoir system comprising a production well and a production well environment, wherein the production well environment further comprises authigenic mineral precipitating bacteria, a rock matrix and a gas or fluid; b) providing an authigenic mineral precursor solution and an authigenic mineral-precipitation inducer; and c) contacting the production well environment with the authigenic mineral precursor solution and an authigenic mineral-precipitation inducer under conditions whereby the inducer induces the bacteria to precipitate an authigenic mineral from the solution into the rock matrix, wherein the precipitated authigenic mineral scavenges one or more sulfide containing compounds from the gas or fluid in the production well environment, thereby decreasing the amount of the one or more sulfide-containing compounds in the gas or fluid produced from the sulfidogenic reservoir system.

In some embodiments, the method further includes d) determining the concentration of the one or more sulfide-containing compound before and after execution of step c) thereby quantifying the amount by which the one or more sulfide-containing compound has decreased in the gas or fluid produced from the sulfidogenic reservoir system.

In some embodiments, the one or more sulfide-containing compounds are selected from H₂S, HS⁻, S²⁻.

In some embodiments, the sulfidogenic reservoir system is an oil reservoir, a natural gas reservoir, a ground water aquifer, or a CO₂ storage well. In some embodiments, the sulfidogenic reservoir system further contains a ground contaminant. In certain embodiments, the contaminants are selected from radioactive pollution, radioactive waste, heavy metal, halogenated solvents, pesticides, herbicides, and dyes.

In some embodiments, the authigenic mineral precursor solution is selected from a Fe(III) solution, a Fe(II) solution, an elemental Fe solution, a nobel iron nanoparticle solution, an ammonium solution, a phosphate solution, a phosphite solution, a calcium solution, a carbonate solution, or a manganese solution. In preferred embodiments, the authigenic mineral precursor solution is a Fe(II) solution.

In some embodiments, the authigenic mineral-precipitation inducer is selected from nitrate, nitrite, nitrous oxide, nitric oxide, perchlorate, chlorate, chlorite, chlorine dioxide, Fe(III), carbonate, phosphite, phosphate, and oxygen.

In some embodiments, the production well environment is concurrently contacted with the authigenic mineral precursor solution and the authigenic mineral precipitation inducer. In other embodiments, the production well environment is contacted first with the authigenic mineral precursor solution and second with the authigenic mineral precipitation inducer. In certain embodiments, the time period between contacting the production well environment with the authigenic mineral precursor solution and the authigenic mineral precipitation inducer is up to 6 hour, 12 hour, 18 hour, 1 day, 2 day, 4 day, or 6 day.

In some embodiments, the production well environment is contacted with the authigenic mineral precursor solution or the authigenic mineral precipitation inducer for up to 6 hour, 12 hour, 18 hour, 1 day, 2 day, 4 day, 6 day, 8 day, 10 day, or 14 day.

In some embodiments, the authigenic mineral is selected from authigenic iron, zinc, and manganese minerals. In certain embodiments the authigenic minerals are mixed valence minerals, such as vivanite or siderite. In certain embodiments, the authigenic mineral is selected from Fe₂O₃, MnO, Mn₃O₄, Mn₂O₃, MnO₂, Mn₂O₇.

In some embodiments, the precipitated authigenic material is precipitated into the rock matrix around the injection well and extending at least 10 m, 50 m, 100 m, 200 m, 300 m, 400 m, 500 m, 600 m, 700 m, 800 m, or 1,000 m away from the production well.

In some embodiments, the authigenic mineral-precipitating bacteria are iron-oxidizing bacteria or nitrate-dependent Fe(II)-oxidizing bacteria or perchlorate-reducing bacteria.

In some embodiments prior to step a) authigenic mineral-precipitating bacteria are added to the system. In certain embodiments the added authigenic mineral-precipitating bacteria are recombinant bacteria.

In some embodiments, the amount of the one or more sulfide-containing compounds in the gas or fluid produced from the sulfidogenic reservoir system is decreased by at least 1%, 10%, 20%, 40%, 60%, 80%, 90%, 95%, or 99% relative to the amount of sulfide-containing compound present in the gas or fluid prior to execution of step c). In certain embodiments, the decrease in the one or more sulfide-containing compounds can be observed in the gas or fluid produced from the sulfidogenic reservoir system within 1 hour, 2 hour, 4 hour, 6 hour, 8 hour, 10 hour, 12 hour, 18 hour, 1 day, 2 day, 4 day, or 8 day of completion of step c).

In some embodiments, prior to step a), the porosity or surface areas of rock matrices in the production well environment are increased by mechanical, chemical, or biological means. In certain embodiments, the mechanical, chemical, or biological means are induced hydrofracturing, chemical weathering or biological weathering. In certain embodiments, the biological weathering results from the bioproduction of organic or mineral acids, alkalines, or chelators. In certain other embodiments, the chemical weathering results from the introduction of organic or mineral acids, alkalines, or chelators.

In some embodiments the production well embodiment is contacted with the authigenic mineral precursor solution and authigenic mineral-precipitation inducer under conditions whereby the inducer further induces the precursor to chemically precipitate authigenic rock mineral from the solution into the rock matrix, wherein the precipitated authigenic mineral scavenges one or more sulfide containing compounds from the gas or fluid in the production well environment, thereby further decreasing the amount of the one or more sulfide-containing compounds in the gas or fluid produced from the sulfidogenic reservoir system. In certain embodiments, the authigenic mineral precursor solution is a Fe(II) or Fe solution and the precipitated authigenic mineral is an iron oxide. In certain embodiments, the authigenic mineral precursor solution is a Fe(II) or Fe solution and the precipitated authigenic mineral is an iron sulfide. In certain embodiments, the iron sulfide is FeS, Fe₂S₃, or FeS₂. In certain embodiments, the authigenic mineral-precipitation inducer is selected from the group consisting of nitrous oxide, nitric oxide, chlorate, chlorite, hypochlorite, and chlorine dioxide. In certain embodiments, the production well environment is first contacted with the authigenic mineral precursor solution and second with the authigenic mineral precipitation inducer.

In some embodiments, the authigenic mineral precipitation is the result of a reversible reaction. In certain embodiments, the reversible reaction is a redox reaction. In certain embodiments, the method further includes d) dissolving the precipitated authigenic mineral by reversing the authigenic mineral precipitation reaction, thereby releasing the one or more sulfide-containing compound previously scavenged by the precipitated authigenic mineral; e) removing the released one or more sulfide-containing compound from the sulfidogenic reservoir; and f) repeating steps a)-c), thereby decreasing the amount of the one or more sulfide-containing compounds in the sulfidogenic reservoir system. In certain embodiments, steps a)-f) are repeated at least 1, 2, 3, 4, 5, 6, 7, 8, 9, 10, 15, 20, 30, 40, 50, 60, 70, 80, 90, 100, 150, 200, 250, or 300 times.

In some embodiments, the sulfidogenic reservoir system further contains authigenic mineral-dissolving bacteria. In certain embodiments, the authigenic mineral-dissolving bacteria are selected from iron-reducing bacteria and acid-producing bacteria. In preferred embodiments, the authigenic mineral-dissolving bacteria are iron-reducing bacteria. In certain embodiments, the system is contacted with an authigenic mineral dissolving inducer under conditions whereby the authigenic mineral-dissolving inducer induces the authigenic mineral-dissolving bacteria to dissolve the precipitated authigenic mineral. In certain embodiments, the authigenic mineral-dissolving inducer is selected from H₂, acetate, propionate, butyrate, lactate, formate, citrate, ethanol, glucose, hexose, hexane, toluene, phenol, benzoate, propane, ethane, methane, and phosphite. In certain embodiments the authigenic mineral-dissolving bacteria dissolve the precipitated authigenic mineral by reversing the authigenic mineral precipitation reaction. In certain embodiments, the authigenic mineral-dissolving bacteria are added to the system. In certain embodiments, the added authigenic mineral-dissolving bacteria are recombinant bacteria.

In some embodiments, the method further includes d) the sulfidogenic reservoir system of step a) further containing one or more sulfate-reducing bacteria; and e) adding a composition containing one or more chlorine oxyanions to the system, or one or more compounds which yield the one or more chlorine oxyanions upon addition to the system, at a concentration sufficient to inhibit sulfate-reducing activity or the sulfate-reducing bacteria, thereby inhibiting sulfidogenesis and decreasing the amount of the one or more sulfide-containing compounds in the sulfidogenic reservoir system. In certain preferred embodiments, the sulfidogenic reservoir system of step a) further contains an injection well and an injection well environment, whereby the injection well environment contains the sulfate-reducing bacteria and whereby the composition containing one or more chlorine oxyanions is added to the injection well environment.

In some embodiments, the method further includes d) the sulfidogenic reservoir system of step a) further containing one or more (per)chlorate-reducing bacteria; and e) adding a composition comprising one or more chlorine oxyanions to the system, or one or more compounds which yield the one or more chlorine oxyanions upon addition to the system, at a concentration sufficient to stimulate (per)chlorate-reducing activity of the (per)chlorate-reducing bacteria, thereby inhibiting sulfidogenesis and decreasing the amount of the one or more sulfide-containing compounds in the sulfidogenic reservoir system. In certain preferred embodiments, the sulfidogenic reservoir system of step a) further contains an injection well and an injection well environment, wherein the injection well environment contains the (per)chlorate-reducing bacteria, and wherein the composition containing one or more chlorine oxyanions is added to the injection well environment.

In some embodiments, one or more (per)chlorate-reducing bacteria are added to the sulfidogenic reservoir system.

In certain embodiments, the one or more chlorine oxyanions are selected from hypochlorite, chlorine dioxide, chlorite, chlorate, perchlorate, and mixtures thereof. In preferred embodiments the one or more chlorine oxyanions are perchlorate.

In certain embodiments, the method further includes adding nitrite. In certain preferred embodiments, the nitrite is added at a concentration sufficient to inhibit the sulfate-reducing bacteria. In other preferred embodiments the nitrite is added in an amount sufficient to yield a chlorine oxyanion to nitrite ratio of at least 100:1. In certain embodiments the nitrite is added to the system prior to adding the composition containing the one or more chlorine oxyanions to the system, or the one or more compounds which yield the one or more chlorine oxyanions upon addition to the system. In certain other embodiments, the method further includes adding molybdenum to the sulfidogenic reservoir system.

### DESCRIPTION OF THE FIGURES

FIG. 1A diagrammatically depicts secondary and tertiary oil recovery from an oil reservoir by injecting water via an injection well into an oil reservoir to maintain reservoir pressure and to sweep oil from the injection well towards a production well. FIG. 1B diagrammatically depicts a sulfidogenic reservoir system containing injection and production wells and corresponding injection and production well environments (illustrated as circular grey areas). Moreover, the microbial production and turnover of H₂S in the sulfidogenic reservoir is illustrated (see, e.g., FIGS. 2 and 3 for a more detailed description) and two exemplary strategies for controlling the H₂S content in production gases and fluids are presented. According to the first strategy, perchlorate (ClO₄⁻) can be injected into the reservoir, for example at the injection well, inhibit the formation of microbially generated H₂S and stimulate the microbial conversion of H₂S into elemental sulfur (S). Over time, therefore, perchlorate additions can lower the overall sulfide content in the reservoir and ultimately also in production gases and fluids (see also, e.g., FIGS. 2 and 3). However, a more immediate reduction of sulfides in production gases and fluids can be achieved according to a second strategy that involves the precipitation of authigenic sulfide-scavenging minerals in the production well environment (sulfide-scavenging minerals are depicted as light-colored circular area within production well environment). FIG. 1B depicts the precipitation of iron(III)oxide (Fe₂O₃) as a preferred authigenic mineral with sulfide-scavenging properties. Typically, authigenic iron oxide minerals are mixed valence minerals, such as Fe₂O₃, but also including other minerals such as vivianite and siderite. When H₂S reacts with these iron oxide minerals it will both adsorb and react with the iron in the minerals to form FeS (iron sulfide) and FeS₂ (pyrite), both of which are insoluble. In FIG. 1B, the sulfide in its scavenged (adsorbed or chemically reacted) form is represented as [Fe₂O₃(S²⁻)]. In this example, a Fe(II) solution is used as the authigenic mineral precursor solution and nitrate, is used as the authigenic mineral precipitation inducer (authigenic mineral precipitating bacteria not shown). Benefits include the biogeneic production of nitrite (NO₂⁻) and nitrous oxide (NO) which have known inhibitory effects on SRB. Alternatively, nitrite and nitrous oxide may be added to the production well environment to react chemically with Fe(II).

FIG. 2 shows a schematic of redox reactions occurring in a system containing sulfate-reducing bacteria (SRB) and dissimilatory (per)chlorate-reducing bacteria (DPRB) in the presence of sulfate and chlorate ions. SRB reduced sulfate ions (SO₄²⁻) to produce hydrogen sulfide (H₂S). The presence of chlorate ions (ClO₃⁻) can inhibit the formation of H₂S by inhibiting the sulfate-reducing activity of SRB. Without wishing to be bound by theory, it is believed that the inhibitory effect of the chlorate ions is due to inhibition of one or a combination of sulfate uptake by the SRB, inhibition of the ATP-sulfurylase enzyme in SRB, or inhibition of the APS-reductase enzyme in SRB, which are all required for efficient reduction of SO₄ by SRB. Additionally, in the presence of chlorate ions, DPRB can oxidize the H₂S to elemental sulfur coupled with reduction of ClO₃⁻ to chloride ions (Cl⁻). The produced sulfur can then be removed from the system.

FIG. 3 shows a model of the (per)chlorate reduction pathway in dissimilatory (per)chlorate-reducing bacteria (DPRB).

FIG. 4 depicts MPN enumeration of FRC nitrate dependent Fe(II) oxidizers.

FIG. 5 shows an Unrooted Neighbor-Joining phylogenetic tree of the 16S rRNA gene sequence from nitrate-dependent Fe(II) oxidizing bacteria.

FIG. 6 graphically depicts mixotrophic Fe(II) oxidation coupled to nitrate reduction and growth with acetate by strain TPSY.

FIG. 7 graphically depicts lithoautotrophic growth by Pseudogulbenkiania strain 2002 using Fe(II) and nitrate as the electron donor and acceptor, respectively, and CO₂ as the sole carbon source.

FIG. 8 graphically depicts Fe(II) oxidation by A. suillum in anoxic culture medium with acetate as the carbon source and nitrate as the sole electron acceptor. Fe(II) oxidation only occurred after acetate utilization was complete.

FIG. 9A schematically depicts the design of a sand-packed column. FIG. 9 B shows a photograph of an exemplary sand-packed column.

FIG. 10 graphically depicts an exemplary design of a sand-packed column experiment conducted under anaerobic conditions.

FIG. 11A shows chlorate-dependent sulfide oxidation to elemental sulfur (S⁰) by Dechloromarinus strain NSS. H₂S is oxidized to elemental sulfur (S⁰). No oxyanions of sulfur (sulfite, thiosulfite, etc.) are produced even after extended incubation of several weeks. FIG. 11B shows that elemental sulfur is precipitated out of aqueous solution.

FIG. 12 shows sulfide inhibition in marine sediment slurry microcosms after extended incubation for over 250 hours after addition of chlorate and Dechloromarinus strain NSS. In the absence of chlorate and Dechloromarinus strain NSS sulfide is readily produced.

FIG. 13 shows the percent inhibition of sulfidogenesis by the SRB D. vulgaris (DV) after a 24-hour incubation with the (per)chlorate reducing organism A. suillum (PS) and/or chlorate (ClO₃⁻).

FIG. 14 shows a time course showing inhibition of sulfidogenesis by the SRB D. vulgaris (DV) when treated with the (per)chlorate reducing organism A. suillum (PS) and chlorate at 48 hours. As can be seen, the treatment results in immediate inhibition of sulfide production and removal of sulfide from the medium relative to the untreated control, which continues to make sulfide.

### DETAILED DESCRIPTION

### Definitions

As used herein, “authigenic mineral”, “authigenic rock mineral”, and “sedimentary rock” are used interchangeably and refer to mineral deposits that develop from soluble chemicals (e.g., ions and organic compounds) in sediments.

As used herein, “authigenic mineral-precipitating bacteria” refers to bacteria that are able to utilize an authigenic mineral precursor solution to precipitate an authigenic mineral. For example, nitrate-dependent Fe(II)-oxidizing bacteria are a type of “authigenic mineral-precipitating bacteria” that oxidize soluble Fe(II) to Fe(III) precipitates.

As used herein, an “authigenic mineral precursor solution” refers to a solution that contains the substrate, such as soluble ions, that is used by authigenic mineral-precipitating bacteria to form a mineral precipitate. For example, an Fe(II) solution may be utilized by nitrogen-dependent Fe(II)-oxidizing bacteria to convert soluble Fe(II) to an Fe(III) precipitate.

As used herein, an “authigenic mineral-precipitation inducer” refers to a composition, for example, a chemical, ionic salt, electron donor, electron acceptor, redox reagent, etc., that induces, in the authigenic mineral-precipitating bacteria, an authigenic mineral-precipitating reaction. For example, an authigenic mineral-precipitation inducer may be an oxidizing agent (i.e., an electron acceptor) that allows the bacteria to precipitate an authigenic mineral from an authigenic mineral precursor solution by oxidizing the precursor solution.

As used herein “precipitated authigenic rock mineral” refers to authigenic rock mineral that can be precipitated. Preferably, the authigenic rock mineral is precipitated by authigenic mineral-precipitating bacteria of the present disclosure.

As used herein, “authigenic mineral-dissolving bacteria” refers to bacteria that are able to dissolve authigenic minerals by reversing the authigenic mineral-precipitation reaction induced by authigenic mineral-precipitating bacteria to precipitate an authigenic mineral. For example, authigenic mineral-dissolving bacteria may reduce a component of an authigenic mineral rock, which solubilizes the mineral (e.g., Fe(III)-reducing bacteria convert insoluble Fe(III) into soluble Fe(II)).

As used herein an “authigenic mineral-dissolving inducer” refers to a composition, for example, a chemical, ionic salt, electron donor, electron acceptor, redox reagent, etc., that induces, in the authigenic mineral-dissolving bacteria, the reverse reaction of an authigenic mineral-precipitating reaction. For example, an authigenic mineral-dissolving inducer may be a reducing agent (i.e., an electron donor) that allows the bacteria to solubilize an authigenic mineral precipitate by reducing a component of the precipitate, such as acetate.

As used herein “chemical precipitation of authigenic rock mineral” and “chemically precipitated authigenic rock mineral” refers to authigenic rock mineral that is precipitated as a result of a chemical reaction and without the involvement of authigenic mineral-precipitating bacteria. For example, authigenic iron oxide may be precipitated as the result of a chemical reaction of Fe(II) with nitrite (NO₂⁻) and nitrous oxide (NO).

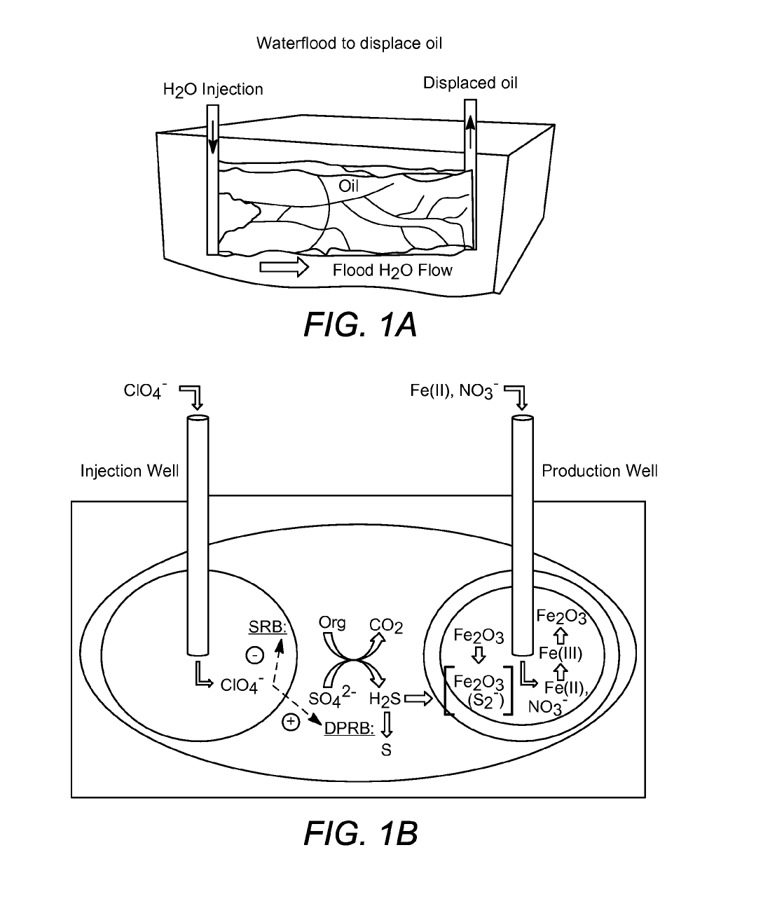

As used herein “production gas” or “production fluid” refers to gases or fluids produced at the production well of a reservoir. For production gases or fluids to reach the production well they have to pass through the production well environment (see, e.g., FIGS. 1A and 1B).

As used herein “scavenger” refers to any substance that is added to a mixture to remove or counteract the effect of impurities. Similarly, as used herein, “scavenging” refers to the activity of a scavenger, i.e., a substance's activity of removing or counteracting the effect of impurities in a mixture. For example, a scavenger may remove an impurity, such as a sulfide-containing compound, from a gas or fluid mixture through physical adsorption or by means of a chemical reaction, such as the precipitation of a mineral. Specifically, iron oxide minerals, such as Fe₂O₃, vivanite, or siderite minerals, may scavenge sulfide-containing compounds from liquids by adsorbing the sulfides to the iron oxide mineral. Alternatively, iron minerals may scavenge sulfide containing compounds by fixing the soluble sulfides in insoluble iron sulfide minerals, such as FeS (iron sulfide), Fe₂S₃ or FeS₂ (Pyrite).

### Overview

The following description sets forth exemplary methods, parameters and the like. It should be recognized, however, that such description is not intended as a limitation on the scope of the present disclosure but is instead provided as a description of exemplary embodiments.

The injection of water into an oil reservoir via one or more injection wells is a commonplace practice to increase oil production beyond primary production yields by maintaining reservoir pressure and sweeping oil from the injection wells towards the production wells (FIG. 1). However, many sources of water, including especially seawater, are rich in sulfate and sulfate reducing bacteria (SRB) that utilize the hydrocarbons, fatty acids, and gases stored in the oil reservoir to reduce sulfate to hydrogen sulfide (H₂S). Consequently, water injection into an oil-reservoir frequently increases the amount of sulfide-containing compounds in gases and fluids produced from the reservoir. This effect is referred to as “reservoir souring.” Due to their toxic and corrosive nature, however, sulfide-containing compounds are considered undesirable contaminants.

The sulfide contents of gases and fluids produced from a reservoir may be controlled by inhibiting the microbial production or by stimulating the microbial turnover of sulfide-containing compounds. However, the exercise of such metabolic control would most commonly be initiated at the injection well as the site of water entry into the system and attempt to lower the sulfide contents in the entire reservoir. However, addressing the microbial sulfide metabolism would have only a delayed effect on lowering the sulfide contents of fluids and gases produced at the production well.

The present disclosure relates to methods for lowering the amount of sulfides in gases and fluids produced at the production well. The methods of the present disclosure achieve these lowered sulfide contents in production gases and fluids by utilizing authigenic mineral-precipitating bacteria to precipitate sulfide-scavenging authigenic minerals in the rock matrices of production well environments. The precipitated authigenic minerals will scavenge sulfides from the gases and fluids in the production well environment and thereby lower the sulfide content in production fluids and gases. Advantageously, when the sulfide-scavenging authigenic minerals are saturated with sulfide-containing compounds, the authigenic minerals can be dissolved by inducing activity of authigenic mineral-dissolving bacteria to reverse the authigenic-precipitating reaction induced by the authigenic-precipitating bacteria. As a result, the scavenged sulfides will be released and can subsequently be “rinsed” from the production well environment.

Accordingly, the present disclosure provides methods for decreasing one or more sulfide containing compounds in gases or fluids produced from a sulfidogenic reservoir system, by a) providing a sulfidogenic reservoir system containing a production well and a production well environment, whereby the production well environment further contains authigenic mineral precipitating bacteria, a rock matrix, and gases or fluids; b) providing an authigenic mineral precursor solution and an authigenic mineral-precipitation inducer; and c) contacting the production well environment with the authigenic mineral precursor solution and the authigenic mineral-precipitation inducer under conditions whereby the inducer induces the bacteria to precipitate an authigenic mineral from the solution into the rock matrix, where the precipitated authigenic mineral scavenges one or more sulfide containing compounds from the gases or fluids in the production well environment, thereby decreasing the amount of the one or more sulfide-containing compounds in the gases or fluids produced from the sulfidogenic reservoir system.

In some embodiments, the method further includes d) determining the concentration of the one or more sulfide-containing compound before and after execution of step c), thereby quantifying the amount by which the one or more sulfide-containing compound has decreased in the gas or fluid produced from the sulfidogenic reservoir system.

### Exemplary Systems Treated

The methods of this disclosure can be used to treat any sulfidogenic reservoir system from which gases or fluids are produced that contain one or more sulfide-containing compounds, such as hydrogen sulfide or HS⁻. Examples of sulfidogenic reservoir systems include oil reservoirs, natural gas reservoirs, aquifers, and CO₂ storage wells.

The reservoir systems of this disclosure generally have one or more injection wells and production wells. In the course of secondary recovery processes, water is injected at the injection well, while fluids or gases are produced at the production well. Production wells are surrounded by production well environments and injection wells are surrounded by injection well environments. Production well environments and injection well environments may extend up to 10 m, 50 m, 100 m, 200 m, 300 m, 400 m, 500 m, 600 m, 700 m, 800 m, 900 m, 1,000 m, 2,000 m, 3,000 m, 4,000 m, or 5,000 m away from the respective wells. The production and injection well environments may extent from the respective wells in an approximately radial pattern. Alternatively, the shapes of the injection and production well environments may deviate from the radial pattern. Deviations from the radial pattern may result from the rock geology in the injection and production well environments; such as the presence of multiple rock layers featuring different degrees of rock density or porosity. Fluid viscosities and pressure differentials across a reservoir fluid pool may also result in deviations from a radial pattern. Both injection and production well environments generally contain rock matrices, a gas and/or a fluid, and authigenic mineral precipitating bacteria. In some embodiments the authigenic mineral precipitating bacteria are indigenous in the injection or production well environments.

### Process for Treating the Production Well Environment

The methods of this disclosure provide for treatments of the production well environment with an authigenic mineral precursor solution and an authigenic mineral precipitation inducer. The inducer induces authigenic mineral precipitating bacteria to precipitate an authigenic mineral from the precursor solution into the rock matrix. The precipitated authigenic mineral scavenges sulfide-containing compounds from the gas or fluid in the production well environment.

### Application of Authigenic Mineral Precursor Solutions and Authigenic Mineral-Precipitation Inducers

Generally, the precursor and inducer are contacted with the production well environment by injecting solutions containing the precursor and inducer into the production well. However, in some embodiments, the precursor and inducer are injected through wells other than the production well.

According to this disclosure, gases or fluids are generally not produced at the production well while the production well environment is contacted with the authigenic mineral precursor solution or the authigenic mineral precipitation inducer. In some embodiments, the interim time period between completing the injection of the precursor and the inducer into the production well environment and resuming the production of gases or fluids at the production well may amount to at least a 1 hour, 2 hour, 4 hour, 6 hour, 12 hour, 18 hour, 1 day, 2 day, 4 day, 6 day, or 8 day period.

The authigenic mineral precursor solution and the authigenic mineral-precipitation inducer may be contacted with the production well environment concurrently or sequentially. In certain preferred embodiments, the production well environment is contacted with the precursor first and only subsequently contacted with the inducer. Accordingly, in some embodiments, the authigenic mineral precursor solution and the authigenic mineral-precipitation inducer are provided in a single composition. Alternatively, the authigenic mineral precursor solution and the authigenic mineral-precipitation inducer may be provided separately.

The production well environment may be contacted with the authigenic mineral precursor solution or the authigenic mineral-precipitation inducer for time periods up to 6 hours, 12 hours, 18 hours, 1 day, 2 days, 4 days, 6 days, 8 days, 10 days, 12 days, or 14 days, either individually or in combination. In embodiments where the precursor and inducer are sequentially contacted with the production well environment the interim time period between contacting the production well environment with the precursor and the inducer may extend up to 6 hour, 12 hour, 18 hour, 1 day, 2 day, 4 day, or 6 day periods.

In embodiments where exogenous authigenic mineral-precipitating bacteria are added to a rock matrix-containing system, the authigenic mineral precursor solution and the authigenic mineral-precipitation inducer may be added to the system concurrently with the bacteria. In other embodiments, the authigenic mineral precursor solution and the authigenic mineral-precipitation inducer are added after the addition of bacteria.

In other embodiments, the ratio of authigenic mineral precursor solution to authigenic mineral-precipitation inducer that is added to the rock matrix-containing system is at least 2:1, at least 3:1, at least 4:1, at least 5:1, at least 6:1, at least 7:1, at least 8:1, at least 9:1, at least 10:1, or more. In embodiments where the authigenic mineral precursor solution is an Fe(II) solution and the authigenic mineral-precipitation inducer is nitrate, the ratio of Fe(II) solution to nitrate that is added to the rock matrix-containing system is at least 2:1, at least 3:1, at least 4:1, at least 5:1, at least 6:1, at least 7:1, at least 8:1, at least 9:1, at least 10:1, or more. Preferably, the ratio of Fe(II) solution to nitrate that is added to the rock matrix-containing system is 5:1.

### Authigenic Mineral Precursor Solutions

As disclosed herein, authigenic mineral precursor solutions provide the substrate that is utilized by the authigenic mineral-precipitating bacteria to produce authigenic mineral. For example, in the case of Fe(II)-oxidizing bacteria, an Fe(II) solution provides the soluble Fe(II) substrate for the formation of iron oxide mineral precipitates.

Authigenic mineral precursor solutions of the present disclosure are provided to authigenic mineral-precipitating bacteria under conditions whereby the bacteria utilize the solution to precipitate authigenic mineral into a rock matrix-containing system of the present disclosure. Generally, the conditions will depend on the type of bacteria present in the rock matrix-containing system, the type of authigenic rock matrix present in the system, and the subsurface conditions of the rock matrix-containing system.

Examples of suitable authigenic mineral precursor solutions include, without limitation, Fe (II) solutions, Fe(III) solutions, noble iron nanoparticle solutions, ammonia solutions, phosphate solutions, phosphite solutions, calcium solutions, carbonate solutions, and manganese solutions.

### Authigenic Mineral-Precipitation Inducers

As disclosed herein, authigenic mineral-precipitation inducers are solutions containing, for example, chemicals, ionic salts, chelators, electron donors, electron acceptors, or redox reagents that induce the authigenic mineral-precipitating activity in the authigenic mineral-precipitating bacteria. For example, in the case of nitrate-dependent Fe(II)-oxidizing bacteria, nitrate can serve as the inducer, as its reduction is coupled to Fe(II) oxidization in the bacteria, which results in the precipitation of Fe(III) oxides.

Authigenic mineral-precipitation inducers of the present disclosure are provided to authigenic mineral-precipitating bacteria under conditions whereby the inducer induces the bacteria to reversibly precipitate authigenic mineral from an authigenic mineral precursor solution into a rock matrix-containing system of the present disclosure. Generally, the conditions will depend on the type of bacteria present in the rock matrix-containing system, the type of authigenic rock matrix present in the system, and the subsurface conditions of the rock matrix-containing system.

Examples of suitable authigenic mineral-precipitation inducers include, without limitation, nitrous oxide, nitric oxide, nitrite, nitrate, perchlorate, chlorate, chlorite, chlorine dioxide, carbonate, phosphite, phosphate, and oxygen. In certain embodiments, combinations of these mineral-precipitation inducers may be used. In preferred embodiments, a combination of nitrite and nitrous oxide, or perchlorate are used.

In some embodiments, the authigenic mineral precipitation inducer may induce the authigenic mineral precursor through a chemical reaction that does not involve the participation of authigenic mineral precipitating bacteria. These chemically precipitated authigenic rock minerals are sulfide scavengers and can decrease the amount of sulfide-containing compounds in gases and fluids in the production well environment. In certain embodiments, the authigenic mineral-precipitation inducers N₂O, NO or NO₂⁻, hypochlorite, chlorite, chlorine dioxide, or chlorate individually or in combination, oxidize the authigenic mineral precursor Fe(II) to Fe(III) and thereby induce the chemical precipitation of iron oxide minerals, such as Fe₂O₃, under the alkaline conditions of the production well environment; Fe₂O₃ subsequently scavenges sulfide-containing compounds from production gases and fluids (see also FIG. 1B, chemical precipitation of Fe₂O₃ and subsequent sulfide scavenging (illustrated as [Fe₂O₃(S²⁻)] formation) may occur with or without the involvement of authigenic mineral precipitating bacteria.). Especially, chlorate and other oxidants having a low activation energy, react rapidly with Fe(II) to chemically precipitate iron oxide minerals.

In some embodiments, the authigenic mineral precipitation inducer may induce the authigenic precursor to chemically precipitate sulfide-containing compounds from the gas or fluid in the production well environment. In preferred embodiments, the precursor is Fe(II) and the inducer is selected from nitrous oxide, nitric oxide, chlorate, chlorite, chlorine dioxide, and hypochlorite. In certain embodiments, the precipitation inducer chlorate chemically oxidizes the precursor Fe(II) to produce Fe(III); Fe(III) would subsequently precipitate S₂⁻ forming Fe₂S₃.

### Authigenic Minerals

According to this disclosure, authigenic minerals precipitated in the production well environment can scavenge one or more sulfide-containing compounds from the gases or fluids located in the production well environment. Generally, any authigenic mineral with sulfide-scavenging properties may be used. This includes any authigenic minerals that can remove or counteract the effect of sulfide-containing compounds in production gases or fluids. It is known in the art that a broad range of metal ions can precipitate soluble sulfide-containing compounds out of solution; it is similarly known that a broad range of metal oxides can adsorb or react with soluble sulfide-containing compounds.

In some embodiments, the authigenic mineral may remove the sulfide-containing compounds from the production fluid through physical adsorption. In other embodiments, the authigenic mineral may remove the sulfide-containing compounds by means of a chemical reaction, such as the precipitation of an insoluble sulfide mineral. Authigenic minerals remove sulfide-containing compounds from the production fluid during their formation, i.e. when the sulfide-containing compound is precipitated out of solution by reacting with another ion, such as Fe³⁺ or Mn²⁺ ions.

Exemplary authigenic minerals with sulfide-scavenging properties include iron minerals, such as the iron oxides Fe₂O₃, vivianite, and siderite, zinc minerals, such as zinc oxides, and manganese minerals, such as manganese oxides (e.g., MnO, Mn₃O₄, Mn₂O₃, MnO₂, or Mn₂O₇). In certain embodiments the authigenic minerals are mixed valence minerals such as Fe₂O₃, vivianite, green rust, and siderite. In certain embodiments, the authigenic minerals are iron oxides that scavenge soluble sulfide-containing compounds by adsorbing or precipitating these soluble sulfides and reacting with these to form insoluble iron sulfide minerals, such as Fe₂S₃, FeS₂ (Pyrite), or FeS. In certain other embodiments, the authigenic minerals are sulfide minerals, such as Fe₂S₃, FeS₂ (Pyrite), FeS, MnS, or ZnS that were formed by cations, such as Fe³⁺, Mn²⁺, or Zn²⁺ ions, precipitating sulfide compounds from solution.

In some embodiments, authigenic minerals are precipitated in the production well environment in a radial pattern around the production well and may extend up to 10 m, 50 m, 100 m, 200 m, 300 m, 400 m, 500 m, 600 m, 700 m, 800 m, 1,000 m, 2,000 m, 3,000 m, 4,000 m, or 5,000 m away from the production well.

In some embodiments, scavenging of sulfide-containing compounds by precipitated authigenic minerals in the production well environment decreases the amount of the sulfide-containing compounds in the gas or fluid produced from the sulfidogenic reservoir by up to 1%, 2%, 4%, 6%, 8%, 10%, 15%, 20%, 30%, 40%, 50%, 60%, 70%, 80%, 90%, 95%, 99%, or 99.9% relative to the amount of sulfide-containing compound present in the gas or fluid prior to the precipitation of the authigenic minerals. In certain embodiments, the decrease in the sulfide-containing compound can be observed in the production gases and fluids within 1 hour, 2 hour, 4 hour, 6 hour, 8 hour, 10 hour, 12 hour, 18 hour, 1 day, 2 day, 4 day, or 8 day after precipitation of the authigenic minerals.

Some embodiments may further include steps for increasing the rock matrix porosity and surface areas in production well environments. Exemplary additional steps may include hydraulic fracturing and mechanical, chemical, or biological weathering of rock matrices. Hydraulic fracturing generally involves the propagation of fractures in a rock layer and includes induced hydraulic fracturing or hydrofracturing (“fracking”). Other techniques may include biological or chemical weathering of the rock surfaces through the introduction or bioproduction of organic or mineral acids, alkalies, or chelators. In certain embodiments that include additional steps, the sulfide-containing compounds in the production gas or fluid can be further reduced by at least 1%, 5%, 10%, 20%, 30%, 40%, or 50% relative to embodiments that do not include additional steps.

### Authigenic Mineral-Precipitating Bacteria

Certain aspects of the present disclosure relate to methods of precipitating authigenic rock mineral by inducing authigenic mineral-precipitating bacteria that are present in systems containing rock matrix to precipitate authigenic mineral into a rock matrix. Examples of systems containing rock matrix include, without limitation, oil reservoirs, oil fields, aquifers, and subsurface geological formations.

Authigenic mineral-precipitating bacteria that are suitable for use with the methods of the present disclosure include both archaebacteria and eubacteria. Suitable authigenic mineral-precipitating bacteria also include aerobic bacteria and anaerobic bacteria that are be physchrophilic, mesophilic, thermophilic, halophic, halotolerant, acidophilic, alkalophilic, barophilic, barotolerant, or a mixture of several or all of these and intermediates thereof. Preferably, authigenic mineral-precipitating bacteria of the present disclosure are anaerobic bacteria, as anaerobic bacteria have suitable tolerance for the restricted availability of oxygen, extreme temperatures, extreme pH values, and salinity that may be encountered in the subsurface environments of the rock matrix-containing systems of the present disclosure.

Moreover, it has been previously shown that mineral-precipitating bacteria are ubiquitous and active in various environments, such as aquatic environments, terrestrial environments, and subsurface environments. Accordingly, authigenic mineral-precipitating bacteria of the present disclosure are able to sustain the metabolic activity that results in authigenic mineral precipitation in the subsurface environments of rock matrix-containing systems of the present disclosure.

Other examples of suitable authigenic mineral-precipitating bacteria include, without limitation, iron-precipitating bacteria, phosphorous mineral-precipitating bacteria, calcium mineral-precipitating bacteria, apatite mineral mineral-precipitating bacteria, and carbonate mineral-precipitating bacteria, magnesium mineral-precipitating bacteria, and manganese mineral-precipitating bacteria, and sulfur mineral-precipitating bacteria. Examples of such bacteria include, without limitation, Proteobacterial species, Escherichia species, Roseobacter species, Acidovorax species, Thiobacillus species, Pseudogulbenkiania species, Pseudomonas species, Dechloromonas species, Azospira species, Geobacter species, Desulfotignum species, Shewanella species, Rhodanobacter species, Thermomonas species, Aquabacterium species, Comamonas species, Azoarcus species, Dechlorobacter species, Propionivibrio species, Magnetospirillum species, Parvibaculm species, Paracoccus species, Firmicutal species, Desulfitobacterium species, Sporosarcina species, Bacillus species, Acidobacterial species, Geothrix species, Archaeal species, and Ferroglobus species.

Such mineral-precipitating bacteria precipitate various minerals, including without limitation, calcium sulfate (gypsum), magnesium carbonate, ferric oxide, ferric oxyhydroxide (e.g., maghemite, hematite, goethite, etc.), mixed valence iron minerals (e.g., magnetite, green rust, etc.), ferric phosphate, ferrous phosphate ferric carbonate, manganese oxides and mixed valence manganese minerals (e.g., hausmannite, etc.). In some embodiments, the authigenic mineral-precipitating bacteria are selected from iron-oxidizing bacteria, nitrate-dependent Fe(II)-oxidizing bacteria, perchlorate-reducing bacteria, and chlorate-reducing bacteria. In preferred embodiments, the authigenic mineral-precipitating bacteria are iron-oxidizing bacteria.

Generally, authigenic mineral-precipitating bacteria of the present disclosure utilize authigenic mineral precursor solutions and authigenic mineral-precipitation inducers to induce a reaction that results in authigenic mineral precipitation. In some embodiments, the reaction is a reversible reaction. In certain embodiments, the reversible reaction is a redox reaction.

The authigenic mineral-precipitating bacteria of the present disclosure may also contain one or more of the following genes: type-b cytochrome genes, type-c cytochrome genes, and type-a cytochrome genes.

In some embodiments of the present disclosure, the authigenic mineral-precipitating bacteria are nitrate-dependent Fe(II)-oxidizing bacteria. Nitrate-dependent Fe(II)-oxidizing bacteria can precipitate solid-phase iron minerals from the metabolism of soluble Fe²⁺, which couples Fe(II) oxidation with nitrate reduction. These bacteria are capable of changing the valence state of added soluble ferrous iron [Fe(II)] precipitating out insoluble ferric minerals [Fe(III)].

Accordingly, in certain embodiments of the methods of the present disclosure, authigenic mineral-precipitating bacteria are nitrate-dependent Fe(II)-oxidizing bacteria that precipitate iron minerals when induced with an Fe(II) solution and nitrate.

Additionally, Fe(II)-oxidizing bacteria can oxidize the Fe(II) content of native mineral phase Fe(II) in rock matrices, thus altering the original mineral structure resulting in rock weathering and mineral biogenesis. For example, Fe(II)-oxidizing bacteria can oxidize Fe(II) associated with structural iron in minerals such as almandine, an iron aluminum silicate, yielding amorphous and crystalline Fe(III) oxide minerals. In some embodiments, Fe(II) oxidation occurs at a pH of about 2.0, 2.5, 3.0, 3.5, 4.0, 4.5, 5.0, 5.5, 6.0, 6.5, 6.6, 6.7, 6.8, 6.9, 7.0, 7.1, 7.2, 7.3, 7.4, 7.5, or higher.

Moreover, in addition to nitrate, iron-oxidizing bacteria may also couple nitrite, nitric oxide, nitrous oxide; perchlorate, chlorate, chlorine dioxide, hypochlorite, or oxygen reduction with Fe(II) oxidation.

Examples of iron-oxidizing bacteria that may be found in rock matrix-containing systems of the present disclosure include, without limitation, Geobacter sp., Acidovorax sp. and Pseudogulbenkiania sp., Dechloromonas sp., Dechloromonas sp., and Azospira sp., Magnetospirillum sp., Pseudomonas sp.

Iron-oxidizing bacteria of the present disclosure can precipitate various iron minerals. Examples of such iron minerals include, without limitation, iron hydr(oxide)s; iron carbonates; Fe(III)-oxides, such as 2-line ferrihydrite, goethite, lepidocrocite, and hematite; and mixed-valence iron minerals, such as green rust, maghemite, magnetite, vivianite, almandine, and siderite.

Fe(II)-oxidizing bacteria of the present disclosure may also oxidize solid phase Fe(II), including, without limitation, surface-bound Fe(II), crystalline Fe(II) minerals (siderite, magnetite, pyrite, arsenopyrite and chromite), and structural Fe(II) in nesosilicate (almandine and staurolite) and phyllosilicate (nontronite). This reversible oxidative transformation of solid phase Fe(II) in an anoxic environment provides an additional mechanism for rock weathering for altering authigenic rock hydrology.

### Exogenously Added Authigenic Mineral-Precipitating Bacteria

The methods of the present disclosure may utilize authigenic mineral-precipitating bacteria that are indigenous to the rock matrix-containing systems of the present disclosure. However, in systems where the indigenous population of authigenic mineral-precipitating bacteria is not sufficient to be utilized in the methods of the present disclosure, exogenous authigenic mineral-precipitating bacteria may be added to the system. For example, exogenous authigenic mineral-precipitating bacteria may be introduced into the subsurface rock matrix of an oil reservoir by adding a culture broth containing the exogenous authigenic mineral-precipitating bacteria into the injection well of an oil reservoir. Culturing media and methods of culturing bacteria are well known in the art. Suitable authigenic mineral-precipitating bacteria that may be exogenously added include any of the authigenic mineral-precipitating bacteria disclosed herein. Accordingly, in some embodiments, authigenic mineral-precipitating bacteria are added to the system.

In other embodiments, exogenously added authigenic mineral-precipitating bacteria may be isolated from a broad diversity of environments including aquatic environments, terrestrial environments, and subsurface environments. Mutants and variants of such isolated authigenic mineral-precipitating bacteria strains (parental strains), which retain authigenic mineral-precipitating activity can also be used in the provided methods. To obtain such mutants, the parental strain may be treated with a chemical such as N-methyl-N′-nitro-N-nitrosoguanidine, ethylmethanesulfone, or by irradiation using gamma, x-ray, or UV-irradiation, or by other means well known to those practiced in the art.

The term “mutant of a strain” as used herein refers to a variant of the parental strain. The parental strain is defined herein as the original isolated strain prior to mutagenesis.

The term “variant of a strain” can be identified as having a genome that hybridizes under conditions of high stringency to the genome of the parental strain. “Hybridization” refers to a reaction in which a genome reacts to form a complex with another genome that is stabilized via hydrogen bonding between the bases of the nucleotide residues that make up the genomes. The hydrogen bonding may occur by Watson-Crick base pairing, Hoogstein binding, or in any other sequence-specific manner. The complex may comprise two strands forming a duplex structure, three or more strands forming a multi-stranded complex, a single self-hybridizing strand, or any combination of these. Hybridization reactions can be performed under conditions of different “stringency.” In general, a low stringency hybridization reaction is carried out at about 40° C. in 10×SSC or a solution of equivalent ionic strength/temperature. A moderate stringency hybridization is typically performed at about 50° C. in 6×SSC, and a high stringency hybridization reaction is generally performed at about 60° C. in 1×SSC.

In certain embodiments, the exogenously added authigenic mineral-precipitating bacteria can be modified, e.g., by mutagenesis as described above, to improve or enhance the authigenic mineral-precipitating activity. For instance, Fe(II)-oxidizing bacteria may be modified to enhance expression of endogenous genes which may positively regulate a pathway involved in Fe(II) oxidation. One way of achieving this enhancement is to provide additional exogenous copies of such positive regulator genes. Similarly, negative regulators of the pathway, which are endogenous to the cell, may be removed.

The genes in authigenic mineral-precipitating bacteria encoding proteins involved in authigenic mineral-precipitation may also be optimized for improved authigenic mineral-precipitating activity. As used herein, “optimized” refers to the gene encoding a protein having an altered biological activity, such as by the genetic alteration of the gene such that the encoded protein has improved functional characteristics in relation to the wild-type protein. Methods of optimizing genes are well known in the art, and include, without limitation, introducing point mutations, deletions, or heterologous sequences into the gene.

Accordingly, in certain embodiments, the exogenously added authigenic mineral-precipitating bacteria are recombinant bacteria that may contain at least one modification that improves or enhances the authigenic mineral-precipitating activity of the bacteria.

### Regenerating the Production Well Environment

According to this disclosure, as gases and fluids are produced at the production well, the precipitated authigenic minerals scavenge the sulfide-containing compounds from the gases and fluids passing through the production well environment. However, as more gases and fluids are produced at the production well, increasing amounts of sulfides are scavenged by the precipitated authigenic minerals, thereby increasingly exhausting the minerals' capacity to scavenge additional sulfide containing compounds. In some embodiments, the total amount of sulfide-containing compounds in the sulfidogenic reservoir exceeds the capacity of precipitated authigenic minerals for scavenging sulfide-containing compounds. Once the scavenging capacity of the precipitated authigenic minerals is saturated, sulfide-containing compounds may pass through the production well environment and the content of these sulfide-containing compounds in production gases and fluids will increase. This disclosure provides for additional method steps to regenerate the sulfide-scavenging properties in the production well environment by dissolving the precipitated authigenic mineral.

Accordingly, in embodiments where the authigenic minerals were precipitated in a reversible reaction, such as a redox reaction, regenerating the production well environment involves dissolving the precipitated authigenic minerals and thereby releasing the sulfide-containing compounds previously scavenged by the minerals. In some embodiments, the released sulfides are subsequently removed through the production well. In some embodiments, the authigenic mineral precipitation reaction is reversed in a chemical reaction. In preferred embodiments, the authigenic mineral precipitating reaction is dissolved by authigenic mineral dissolving bacteria.

### Authigenic Mineral-Dissolving Bacteria

Certain aspects of the present disclosure relate to dissolving the authigenic mineral precipitated by authigenic mineral-precipitating bacteria of the present disclosure. Generally, the precipitated authigenic mineral is dissolved by reversing the reaction induced by the authigenic mineral-precipitating bacteria. Preferably, the authigenic mineral precipitating reaction is reversed by authigenic mineral-dissolving bacteria.

As disclosed herein, authigenic mineral-dissolving bacteria contain an authigenic mineral dissolving activity that is mediated by the reverse reaction of the reaction induced by authigenic mineral-precipitating bacteria. The reverse reaction can be induced in authigenic mineral-dissolving bacteria by adding an authigenic mineral-dissolving inducer to the system containing the bacteria. In certain embodiments, the reverse reaction induced by the authigenic mineral-dissolving bacteria is a redox reaction. Accordingly, authigenic mineral-dissolving bacteria of the present disclosure can reverse any authigenic mineral-precipitating reaction induced by authigenic mineral-precipitating bacteria of the present disclosure.

Suitable authigenic mineral-dissolving bacteria include both archaebacteria and eubacteria. Moreover, authigenic mineral-dissolving bacteria may be anaerobic bacteria that are either mesophilic or thermophilic. Additionally, authigenic mineral-dissolving bacteria of the present disclosure are able to sustain the metabolic activity that dissolves authigenic mineral precipitation in the subsurface environments of rock matrix-containing systems of the present disclosure.

Further examples of suitable authigenic mineral-dissolving bacteria include without limitation, bacteria that dissolve iron mineral precipitates, phosphorite mineral precipitates, calcium mineral precipitates, apatite mineral precipitates, carbonate mineral precipitates, manganese mineral precipitates, and silicate mineral precipitates. In some embodiments, the authigenic mineral-dissolving bacteria are selected from iron-reducing bacteria and acid-producing bacteria.

In some embodiments, the authigenic mineral-dissolving bacteria dissolve authigenic mineral precipitants by producing an acid (either organic or inorganic) that sufficiently lowers the pH of the rock matrix-containing system to dissolve the authigenic mineral precipitate. For example, the authigenic mineral precipitate may be dissolved at a pH of about 7.5, 7.0, 6.5, 6.0, 5.5, 5.0, 4.5, 4.0, 3.5, 3.0, 2.5, 2.0, or lower.

Suitable authigenic mineral-dissolving bacteria may include, without limitation, Proteobacterial species, Escherichia species, Shewanella species, Geobacter species, Desulfuromonas species, Pseudomonas species, Dechlorobacter species, Pelobacter species, Firmicutal species, Thermincola species, Thermoterrabacterium species, Thermovenabulum species, Thermolithobacter species, Thermosinus species, Alicyclobacillus species, Anaerobranca species, Carboxydothermus species, Tepidimicrobium species, Alkaliphilus species, Clostridium species, Sulfobacillus species, Bacillus species, Actinobacterial species, Acidimicrobium species, Cellulomonas species, Ferrithrix species, Ferromicrobium species; Acidobacterial species, Geothrix species, Thiobacillus species, Archaeal species, and Ferroglobus species.

In one non-limiting example, it has been shown that the Fe(III)-reducing bacteria Thermincola potens strain JR can reduce insoluble Fe(III) to soluble Fe(II) (see, Wrighton et al., Appl. Environ. Microbiol., 2011).

Embodiments involving mineral dissolving bacteria may be practiced as described for authigenic mineral precipitating bacteria. For example, exogenous mineral dissolving bacteria may be added to the sulfidogenic reservoir system and mineral dissolving bacteria may be optimized to enhance the mineral dissolving activity of wild-type bacteria.

### Authigenic Mineral-Dissolving Inducers

The authigenic mineral-dissolving activity of authigenic mineral-dissolving bacteria is induced by contacting the bacteria with an authigenic mineral-dissolving inducer under conditions whereby the authigenic mineral-dissolving inducer induces the authigenic mineral-dissolving bacteria to dissolve the precipitated authigenic mineral. In embodiments where the system containing rock matrix is an oil reservoir, the authigenic mineral-dissolving inducer may be provided to indigenous authigenic mineral-dissolving bacteria by adding the authigenic mineral-dissolving inducer to the injection well.

In embodiments where exogenous authigenic mineral-dissolving bacteria are added to a rock matrix-containing system, the authigenic mineral-dissolving inducer may be added to the system concurrently with the bacteria. In other embodiments, the authigenic mineral-dissolving inducer is added subsequently to addition of the bacteria.

As disclosed herein, authigenic mineral-dissolving inducers are solutions containing, for example, chemicals, ionic salts, electron donors, electron acceptors, or redox reagents that induce the reverse reaction of an authigenic mineral-precipitating reaction in the authigenic mineral-dissolving bacteria.

Authigenic mineral-dissolving inducers of the present disclosure are provided to authigenic mineral-dissolving bacteria under conditions whereby the authigenic mineral-dissolving inducer induces the authigenic mineral-dissolving bacteria to dissolve the precipitated authigenic mineral in the rock matrix of a rock matrix-containing system of the present disclosure. Generally, the conditions will depend on the type of bacteria present in the rock matrix-containing system, the type of authigenic rock matrix present in the system, and the subsurface conditions of the rock matrix-containing system.

Examples of suitable authigenic mineral-dissolving inducers include, without limitation, H [symbol] 2, methane, ethane, hexane, toluene, phenol, formate, acetate, proprionate, lactate, butyrate, citrate, ethanol, glucose, hexose, benzoate, and phosphite.

### Control of Biogenic Hydrogen Sulfide Production at Injection Well

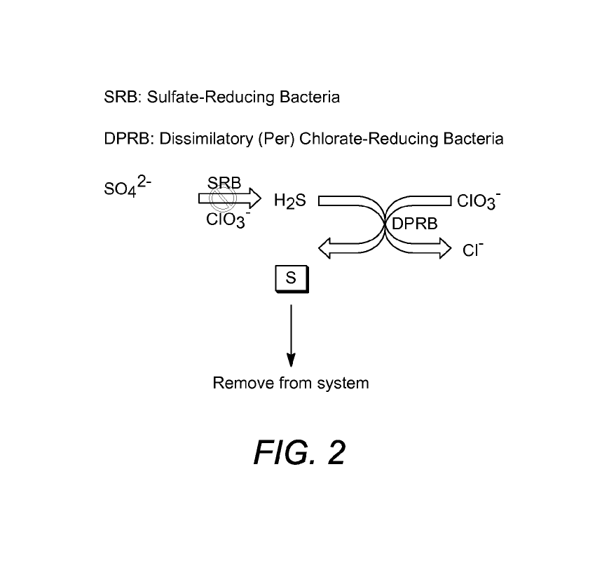

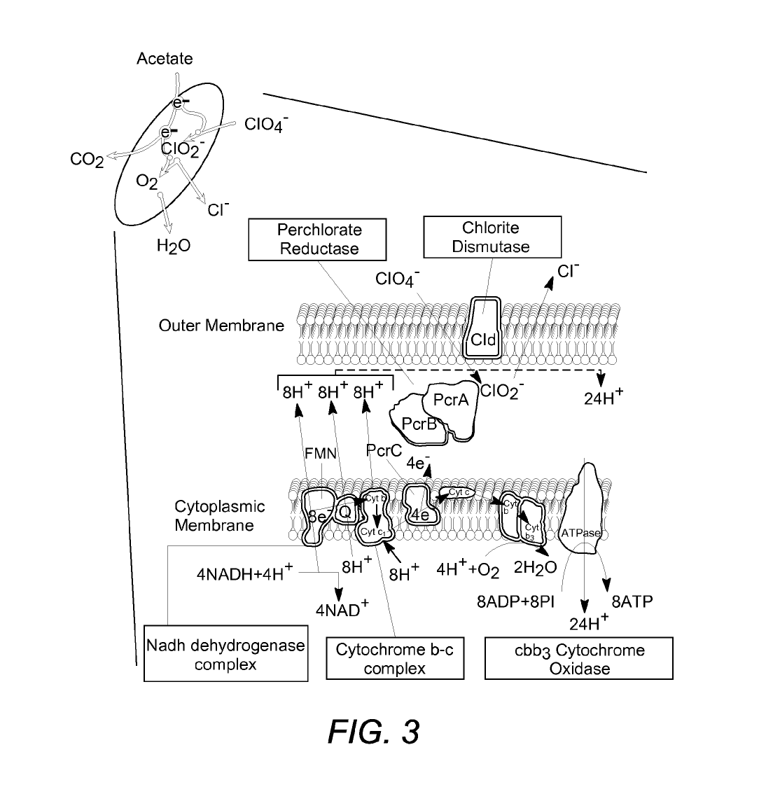

The methods of this disclosure may be combined with other methods for controlling biogenic hydrogen sulfide production and turnover. In some embodiments, biogenic hydrogen sulfide production is controlled by inhibiting the sulfate-reducing activity of sulfate-reducing bacteria (SRB), which convert sulfate to hydrogen sulfide (FIGS. 2 and 3). In other embodiments, biogenic hydrogen sulfide turnover is controlled by stimulating the (per)chlorate-reducing activity of (per)chlorate-reducing bacteria or nitrate-reducing, which oxidize sulfide-containing compounds, e.g., H2S, to elemental sulfur. In some embodiments, biogenic hydrogen sulfide production and turnover are controlled in the injection well environment.

Accordingly, in some embodiments, the methods of this disclosure further include the steps of: d) in the sulfidogenic reservoir system of step a), further providing one or more sulfate-reducing bacteria; and e) adding a composition comprising one or more chlorine oxyanions to the system, or one or more compounds which yield the one or more chlorine oxyanions upon addition to the system, at a concentration sufficient to inhibit sulfate-reducing activity of the sulfate-reducing bacteria, thereby inhibiting sulfidogenesis in the system and decreasing the amount of the one or more sulfide-containing compounds in the sulfidogenic reservoir system. Preferably, the sulfidogenic reservoir system of step a) further includes an injection well and an injection well environment, whereby the injection well environment contains the sulfate-reducing bacteria, and wherein the composition containing one or more chlorine oxyanions is added to the injection well environment.

In some embodiments, the methods of this disclosure further include the steps of: d) in the sulfidogenic reservoir system of step a), further providing one or more (per)chlorate-reducing bacteria; and adding a composition comprising one or more chlorine oxyanions to the system, or one or more compounds which yield the one or more chlorine oxyanions upon addition to the system, at a concentration sufficient to stimulate (per)chlorate-reducing activity of the (per)chlorate-reducing bacteria, thereby inhibiting sulfidogenesis in the system and decreasing the amount of the one or more sulfide-containing compounds in the sulfidogenic reservoir system. Preferably, the sulfidogenic reservoir system of step a) further includes an injection well and an injection well environment, whereby the composition comprising one or more chlorine oxyanions is added to the injection well environment.

Without wishing to be bound by theory, it is believed that chlorine oxyanions (e.g., hypochlorite, chlorite, and chlorine dioxide) may also chemically react with sulfide in sulfide-containing compounds to produce sulfur.

### Sulfate-Reducing Bacteria

Certain aspects of the present disclosure relate to inhibiting sulfate-reduction by (dissimilatory) sulfate-reducing bacteria (SRB). As used herein, the terms “(dissimilatory) sulfate-reducing bacteria (SRB),” “dissimilatory sulfate-reducing bacteria,” “sulfate-reducing bacteria,” and “SRB,” are used interchangeably and refer to microorganisms that are capable of reducing sulfur or its oxyanions to sulfide ions (FIG. 2).

Dissimilatory sulfate-reducing bacteria (SRB) of the present disclosure may reduce sulfate in large amounts to obtain energy and expel the resulting sulfide as waste. Additionally, SRB of the present disclosure may utilize sulfate as the terminal electron acceptor of their electron transport chain. Typically, SRB are capable of reducing other oxidized inorganic sulfur compounds, including, without limitation, sulfite, thiosulfate, and elemental sulfur, which may be reduced to sulfide as hydrogen sulfide.

Dissimilatory sulfate-reducing bacteria (SRB) of the present disclosure are commonly found in sulfate rich environments, such as seawater, sediment, and water rich in decaying organic material. Thus, SRB are common in typical floodwater utilized in oil reservoirs, and are the major cause of sulfide production in oil reservoir souring (Vance and Thrasher, Petroleum Microbiology, eds B. Ollivier & M. Magot, ASM Press, 2005).

Dissimilatory sulfate-reducing bacteria (SRB) of the present disclosure include, without limitation, bacteria from both the Archaea and Bacteria domains. Examples of SRB also include, without limitation, members of the 6 sub-group of Proteobacteria, such as Desulfobacterales, Desulfovibrionales, and Syntrophobacterales. In some embodiments, the SRB are from the species Desulfovibrio.

### (Dissimilatory) (Per)Chlorate-Reducing Bacteria (DPRB)

Other aspects of the present disclosure relate to (dissimilatory) (per)chlorate-reducing bacteria (DPRB), and their use in decreasing the amount of one or more sulfide-containing compounds, and inhibiting SRB-mediated sulfate reduction. As used herein, the terms “(dissimilatory) (per)chlorate-reducing bacteria (DPRB),” “(dissimilatory) (per)chlorate-reducing bacteria,” “dissimilatory (per)chlorate-reducing bacteria,” and “DPRB” may be used interchangeably and refer to microorganisms that have perchlorate- and/or chlorate-reducing activity that allow the microorganisms to metabolize chlorine oxyanions into innocuous chloride ions (FIG. 2). Advantageously, the (per)chlorate-reducing activity of DPRB of the present disclosure can be coupled to sulfide oxidation to reduce and/or eliminate SRB-produced sulfide contaminations in systems of the present disclosure, such as oil reservoirs.

Dissimilatory (per)chlorate-reducing bacteria (DPRB) of the present disclosure contain the (per)chlorate reduction pathway described in (FIG. 3). In particular, DPRB of the present disclosure express at least one (per)chlorate reductase and at least one chlorite dismutase.

Additionally, DPRB of the present disclosure may express one or more of the following gene clusters in total or in part: perABCD (encoding components/accessory genes of perchlorate reductase), crABC (encoding chlorate reductase subunits), cld (encoding chlorite dismutase), cbb3 (encoding cytochrome oxidase), moaA (encoding molybdopterin biosynthesis protein A), QDH (encoding a membrane-associated tetraheme c-type cytochrome with quinol dehydrogenase activity), DHC (encoding a diheme c-type cytochrome), HK (encoding a histidine kinase), RR (encoding a response regulator), PAS (encoding a PAS domain sensor), S (encoding a sigma factor), AS (encoding an anti-sigma factor), and OR (encoding an oxidoreductase component). Further, DPRB of the present disclosure may also contain one or more genes encoding assimilatory nitrate reductases or dissimilatory nitrate reductases.

Moreover, DPRB of the present disclosure can also exhibit a broad range of metabolic capabilities including, without limitation, the oxidation of hydrogen, simple organic acids and alcohols, aliphatic and aromatic hydrocarbons, hexoses, reduced humic substances, both soluble and insoluble ferrous iron, electrically charged cathodes, and both soluble sulfide (e.g., HS−) and insoluble sulfide (e.g., FeS). In some embodiments, the DPRB are facultatively anaerobic or micro-aerophilic with molecular oxygen being produced as a transient intermediate of the microbial reduction of (per)chlorate. Additionally, and without wishing to be bound by theory, it is believed that molybdenum is generally required by DPRB. However, it is unlikely that molybdenum is present in limiting concentrations in the natural environment. Accordingly, in some embodiments, the DPRB may be dependent on molybdenum for their metabolism.

Dissimilatory (per)chlorate-reducing bacteria (DPRB) of the present disclosure may be endogenous to any of the systems of the present disclosure, or may be added exogenously to any system of the present disclosure. Accordingly, in certain embodiments of the method of the present disclosure, the DPRB are endogenous to the system. In other embodiments, methods of the present disclosure include a step of adding exogenous DPRB to the system. For example, exogenous DPRB may be added to system via injection of either active whole cells or starved ultramicrobacteria. In still other embodiments, the exogenous DPRB are added at cell densities suitable to reduce or inhibit the activity of SRB.

### Isolated DPRB

Examples of suitable DPRB having chlorate-reducing activity include, without limitation, Ideonella, Dechloromarinus, Shewanella, and Pseudomonas.

Examples of suitable DPRB having perchlorate- and chlorate-reducing activity include, without limitation, Dechloromarinus; Dechloromarinus strain NSS; Dechloromonas; Dechloromonas strain FL2, FL8, FL9, CKB, CL, NM, MLC33, JM, HZ, CL24plus, CL24, CCO, RCB, SIUL, or MissR; Dechloromonas aromaticae; Dechloromonas hortensis; Magnetospirillum; Magnetospirillum strain SN1, WD, DB, or VDY; Azospirillum; Azospirillum strain TTI; Azospira; Azospira strain AH, Iso1, Iso2, SDGM, PDX, KJ, GR-1, or perc 1 ace; Azospira suillum strain PS; Dechlorobacter; Dechlorobacter hydrogenophilus strain LT-1; Propionivibrio; Propionivibrio strain MP; Wolinella; Wolinella succinogenes strain HAP-1; Moorella; Moorella perchloratireducens; Sporomusa; Sporomusa strain An4; Proteus; Proteus mirabilis; Escherichia; Shewanella; Shewanella alga; Shewanella alga strain ACDC; Shewanella oneidensis strain MR1; Rhodobacter; Rhodobacter capsulatus; Rhodobacter sphaeroides; Alicycliphilus; Alicycliphilus denitroficans; Pseudomonas strain PK, CFPBD, PDA, or PDB; and Pseudomonas chloritidismutans.

In certain preferred embodiments, the DPRB is Azospira suillum, Dechloromonas aromatica or Dechloromarinus strain NSS.

### Mutant and Variant DPRB

Dissimilatory (per)chlorate-reducing bacteria (DPRB) of the present disclosure also include mutants and variants of isolated DPRB strains (parental strains), which retain (per)chlorate-reducing activity. These variants may be obtained using the methods described for producing variants of authigenic mineral precipitating bacteria.

### Recombinant DPRB

Dissimilatory (per)chlorate-reducing bacteria (DPRB) of the present disclosure of the present disclosure may further include microorganisms that do not naturally exhibit (per)chlorate-reducing activity, but where (per)chlorate-reducing activity has been introduced into the microorganism by any recombinant means known in the art.

### DPRB-Mediated Sulfide Oxidation

In certain embodiments, DPRB of the present disclosure can inhibit microbial sulfate-reduction based on thermodynamic preferences, i.e., by competing with SRB for electron donors such as lactate or hydrocarbons, which the DPRB then subsequently use to reduce chlorine oxyanions.

The DPRB employed in the methods of the present disclosure can utilize sulfide-containing compounds, such as H2S, as electron donors to produce elemental sulfur (FIG. 2).

In preferred embodiments, the disclosed methods further include a step of removing from the system, the elemental sulfur produced by the DPRB. Examples of methods of removing sulfur include, without limitation, filtration, centrifugation, and settlement ponds. Additionally, the elemental sulfur may also be used to alter the hydrology in an oil reservoir and improve sweep efficiency.

### Addition of Chlorine Oxyanions or Compounds Yielding Chlorine Oxyanions

The present disclosure provides methods, which include adding chlorine oxyanions or compounds yielding chlorine oxyanions to a system, to decrease the amount of sulfide-containing compounds in the system. In some embodiments, the chlorine oxyanions can be added in a batch or a continuous manner. The method of addition depends on the system being treated. For example, in embodiments where the system is a single oil well, the chlorine oxyanions can be added in a single batch injection. In other embodiment where the system is an entire oil-recovery system, the chlorine oxyanions can be added in a continuous process.

Examples of chlorine oxyanions include, without limitation, hypochlorite, chlorine dioxide, chlorite, chlorate, perchlorate, and mixtures thereof.

In embodiments where the method is used to decrease the amount of sulfide-containing compounds in an oil reservoir, the chlorine oxyanions can be added into injected water at the beginning of the flooding process. Alternatively, the chlorine oxyanions can also be added to makeup waters out in the field after souring has been observed. In other embodiments, the chlorine oxyanions can be added at the wellhead.

In further other embodiments, chlorine oxyanions are added to CO2 storage wells to reduce or inhibit the formation of sour gas by SRB or sulfur oxidizing bacteria present in the storage wells. In this manner, chlorine oxyanions can protect the storage wells from the metal corrosion and concrete corrosion that may occur as the result of sour gas formation.

In the present disclosure, the chlorine oxyanions added are at a concentration sufficient to stimulate (per)chlorate-reducing activity of the DPRB. This concentration is dependent upon the parameters of the system being treated by the provided method. For example, characteristics of the system, such as its volume, surrounding pH, temperature, sulfate concentration, etc., will dictate how much chlorine oxyanions are needed to stimulate the (per)chlorate-reducing activity of the DPRB. Without wishing to be bound by theory, it is believed that a ratio of three S2− ions to one ClO3− ion will completely oxidize all of the sulfide to elemental sulfur. Additionally, it is believed that this ratio changes to 4:1 with perchlorate, and 2:1 with chlorite or chlorine dioxide. Accordingly, in some embodiments, the chlorine oxyanions added are at a ratio with sulfide that is sufficient to completely oxidize the sulfide to elemental sulfur.

In embodiments where perchlorate (ClO4−) is added, the perchlorate can be added in an amount that is at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 80%, at least 85%, at least 90%, at least 95%, or at least 100% of the amount (i.e., concentration) of sulfate present in the system. Methods for determining the concentration of sulfate present in a system, such as oil reservoir, are well known in the art. In one non-limiting example, sea water, which can be used as floodwater in an oil reservoir, has a sulfate concentration of about 25 mM.

The chlorine oxyanions added to the system may be in any desired form. For example, the counter ion is not critical and accordingly any desired form of the chlorine oxyanions may be added so long as the ions perform their desired function. Examples of suitable counter ions include, without limitation, chlorine oxyanion acids and salts of sodium, potassium, magnesium, calcium, lithium, ammonium, silver, rubidium, and cesium.

Compounds, which yield chlorine oxyanions upon addition to the system, can also be used.

### Addition of Other Factors

Certain aspects of the present disclosure relate to adding additional nutrients to a system of the present disclosure to stimulate (per)chlorate-reducing activity of DPRB of the present disclosure; and to adding additional anions, such as nitrite (NO2−) to further inhibit SRB present in the system.

In some embodiments, nutrients can be added to the system, which stimulate (per)chlorate-reducing activity of the DPRB. Examples of such nutrients include, without limitation, molybdenum, additional carbon sources, and/or phosphorous ions (e.g., phosphite and phosphate).

Nitrite, in small amounts, is very toxic to SRB. Accordingly, nitrite can be added in combination with (per)chlorate to inhibit SRB, thereby inhibiting sulfidogenesis. In certain embodiments, the nitrite is added at a concentration sufficient to inhibit the SRB. Generally, the nitrite can be added in combination with (per)chlorate at a (per)chlorate:nitrite ratio of at least 10:1, at least 20:1, at least 30:1, at least 40:1, at least 50:1, at least 60:1, at least 70:1, at least 80:1, at least 90:1, at least 100:1, at least 110:1, at least 120:1, at least 130:1, at least 140:1, at least 150:1, at least 160:1, at least 170:1, at least 180:1, at least 190:1, at least 200:1, or more. In certain preferred embodiments, (per)chlorate and nitrite are added in a ratio of 100:1. For example 10 mM of (per)chlorate and 100 μM of nitrite may be added to the system.

Additionally, nitrate-reducing bacteria can reduce chlorate to chlorite. Moreover, it has been shown that in pure culture that the produced chlorite can kill the nitrate-reducing bacteria. However, without wishing to be bound by theory, it is believed that in a sulfidogenic environment, such as an oil reservoir, the chlorite can inhibit SRB. Accordingly, in certain embodiments, nitrite may be added to a system of the present disclosure, such as an oil reservoir, in an amount sufficient to stimulate nitrate reduction to expand the population of nitrate-reducing bacteria in the system. Once the microbial population has been expanded, chlorine oxyanions, such as (per)chlorate, can be added to biogenically produce chlorite in an amount sufficient to inhibit SRB.

### EXAMPLES

The Examples herein describe a unique approach to achieving a decrease in sulfide contaminants in production gases and fluids from sulfidogenic reservoirs through the microbial production of authigenic rock mineral precipitants that can scavenge the sulfide contaminants in the production well environment of the reservoir. Many microbial processes are known to be involved in solid-phase mineral precipitation, which can be judiciously applied to precipitate authigenic rock minerals with sulfide-scavenging properties. However, to date, there has been little investigation of the applicability of these precipitation events to strategies for the reduction of sulfide contents in production gases and fluids. Such processes can be mediated by microorganisms, such as nitrate-dependent Fe(II)-oxidizing bacteria, which can precipitate solid-phase iron minerals from the metabolism of soluble Fe2+ 1,2. These microorganisms are capable of changing the valence state of added soluble ferrous iron [Fe(II)], precipitating out insoluble ferric minerals [Fe(III)] that have sulfide scavenging properties. Moreover, Fe(II)-oxidizing organisms can oxidize the Fe(II) content of native mineral phase Fe(II) in rock matrices, thus altering the original mineral structure resulting in rock weathering that can enhance the capacity of a rock matrix to scavenge sulfide-containing compounds. Previous studies of these microorganisms have indicated their ubiquity and activity in both extreme and moderate environments and many pure culture examples are also available.

### Example 1

### Microorganisms can Oxidize Soluble Fe(II) Under Anaerobic Conditions Found in Sulfidogenic Reservoir Systems and Precipitate Fe(III)-Minerals

This Example illustrates the identification and the metabolic properties of bacteria capable of oxidizing soluble Fe(II) under conditions found in subterranean environments, such as sulfidogenic reservoir systems. Exemplary bacterial strains were identified that can oxidize soluble Fe(II) under the anaerobic and specific geochemical conditions of sulfidogenic reservoir systems.

At circumneutral pH, ˜pH 7, and greater pH values, such as those commonly found in oil reservoirs, iron primarily exists as insoluble, solid phase minerals in divalent ferrous [Fe(II)] and trivalent ferric [Fe(III)] oxidation states3. In general, the solubility and chemical reactivity of iron is particularly sensitive to the environmental pH. The solubility of the trivalent ferric form [Fe(III)] is inversely proportional to acid pH values and below a pH value of 4.0 Fe(III) primarily exists as an aqueous ionic Fe3+ species.

Under the geochemical conditions of a subterranean reservoir system (e.g., absence of light, low oxygen) the abiotic oxidation of Fe(II) requires either the presence of strong oxidants, such as nitrite (NO2−), chemical catalysts, such as Cu2+, or otherwise extreme reaction conditions (i.e., high temperatures, high pH). Thus, abiotic Fe(II) oxidation is not expected to play a significant quantitative role in naturally occurring iron redox cycling. On the other hand, a range of microbial activities has been identified recently catalyzing the redox cycling of iron in subterranean environments. In fact, today, microbial activities are expected to significantly contribute to the oxidation of Fe(II) in the environment.

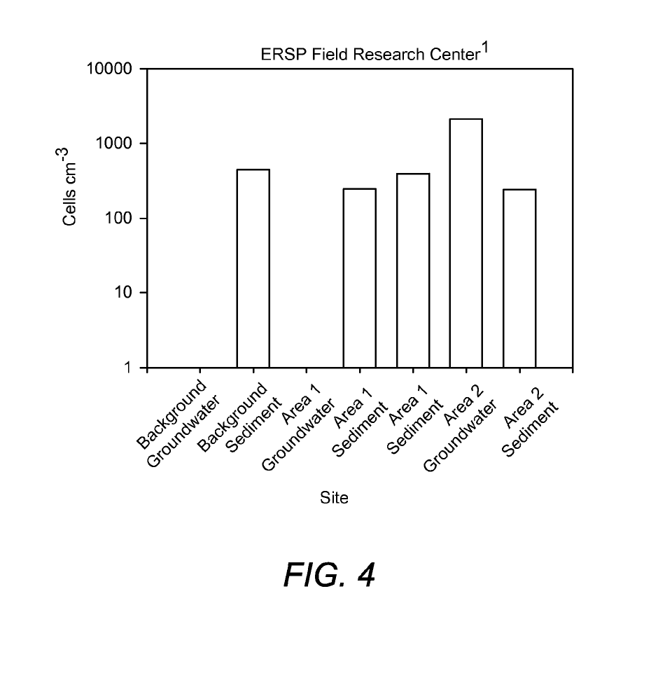

For example, at circumneutral pH, light-independent microbially mediated oxidation of both soluble and insoluble Fe(II) coupled to nitrate reduction has been demonstrated in a variety of freshwater and saline environmental systems. These environmental systems support abundant nitrate-dependent Fe(II)-oxidizing microbial communities in the order of 1×103 to 5×108 cells/g of sediment65. Most probable number (MPN) enumeration studies using subsurface sediments and groundwater samples revealed similar population sizes of anaerobic nitrate-dependent Fe(II)-oxidizing organisms ranging from 0-2.4 103 cells·cm-3 (FIG. 4).

MPN enumeration studies were performed by serially diluting 1 g of sediment from each sediment core interval in triplicate in 9 ml anoxic (80:20 N2:CO2 headspace) bicarbonate-buffered (pH 6.8) freshwater basal medium and containing 5 mM nitrate and 0.1 mM acetate as the electron acceptor and the additional carbon source, respectively. Ferrous chloride was added as the electron donor from an anoxic (100% N2 atmosphere), filter sterilized (0.22 m sterile nylon filter membrane) stock solution (1 M) to achieve a final concentration of 10 mM. Following the addition of 1 g sediment, sodium pyrophosphate (final concentration, 0.1%) was added to the sediment slurry, which was gently shaken at room temperature for 1 h. The sediment slurry was then serially diluted in basal medium prepared as described above. After 8 weeks of incubation in the dark at 30° C., tubes positive for iron oxidation were identified by the presence of a brownish-red or brownish-green precipitate. The Most Probable Number Calculator version 4.05 (Albert J. Klee, Risk Reduction Engineering Laboratory, U.S. Environmental Protection Agency, Cincinnati, Ohio, 1996; freeware available at EPA website) was used to enumerate the nitrate-dependent Fe(II)-oxidizing microbial community and calculate confidence limits.

Anaerobic Fe(II)-oxidizing microorganisms have also been demonstrated to exploit the favorable thermodynamics between Fe(OH₃)/Fe(II) and nitrate reduction redox pairs (NO₃⁻/½N₂, NO₃⁻/NO₂⁻, NO₃⁻/NH₄⁺)^{4, 9, 11, 12} as well as perchlorate (ClO₄⁻/Cl⁻), and chlorate (ClO₃⁻/Cl⁻)⁶⁸. In general, nitrite (NO₂⁻) and nitrogen gas (N₂) are considered the sole end-products of nitrate reduction^{4, 5, 11}. However, this may not always be the case, as it has been recently demonstrated that nitrate-dependent Fe(II) oxidation by the model Fe(III)-reducing organism Geobacter metallireducens results in the production of ammonium⁸.

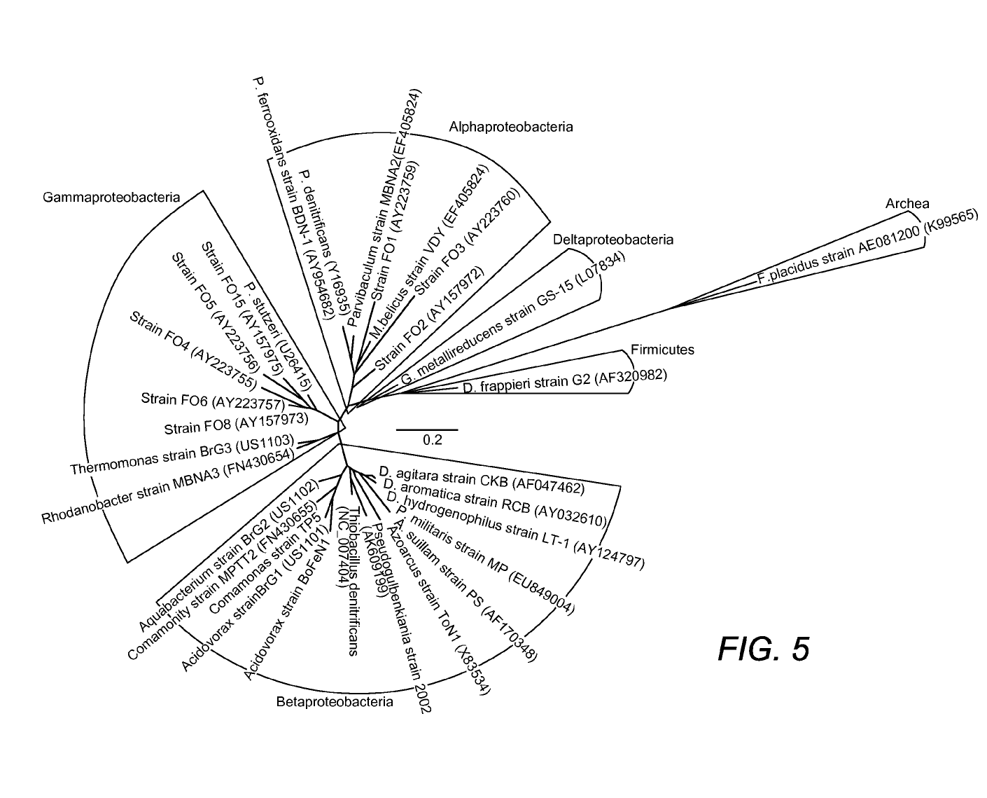

As shown in FIG. 5, nitrate-dependent Fe(II) oxidizing microorganisms are phylogenetically diverse with representatives in both the Archaea and Bacteria. To construct the phylogenetic tree shown in FIG. 5, available quality 16s rRNA gene sequences were aligned with MUSCLE (Edgar, 2004) and phylogeny was computed with MrB ayes 3.2 (Ronquist and Huelsenbeck, 2003). The scale bar in FIG. 5 indicates 0.2 changes per position.

These isolates are also physiologically diverse and represent a range of optimal thermal growth conditions from psychrophilic through mesophilic to hyperthermophilic¹⁰.

Although several environmentally ubiquitous and phylogenetically diverse mesophiles have been described as being capable of nitrate-dependent Fe(II) oxidation¹⁰, in most cases, growth was shown to not be associated with this metabolism or was not demonstrated in the absence of an additional electron donor or organic carbon as an energy source at circumneutral pH^{4, 5, 12, 13}. In order to identify additional known mesophiles that can grow by this metabolism, we have developed a simple plate overlay technique to enrich and isolate Fe(II)-oxidizing organisms. In this technique, samples were streaked onto R2A agar plates (Difco catalog no. 218263), an undefined low-nutrient medium, and amended with 10 mM nitrate in an anaerobic glove bag (95:5 N₂:H₂ atmosphere). The plates were incubated in anaerobic jars at 30° C. for 120 h for heterotrophic colony development. An Fe(II) overlay (5 ml of R2A agar containing 2 mM FeCl₂) was poured over each plate following colony development, and incubation took place in an anoxic atmosphere. Colonies that exhibited Fe(II) oxidation, as identified by the development of brownish-red Fe(III) oxide precipitates on or around colonies, were selected and transferred into anoxic bicarbonate-buffered freshwater basal medium containing 10 mM nitrate, 10 mM Fe(II), and 0.1 mM acetate. After 1 week of incubation in the dark at 30° C., positive cultures were transferred into fresh anoxic bicarbonate-buffered basal medium containing 10 mM Fe(II) and 5 mM nitrate with CO₂ as the sole carbon source.

Using this plat overlay technique we isolated two novel bacteria Diaphorobacter sp. strain TPSY and Pseudogulbenkiania sp. strain 2002.

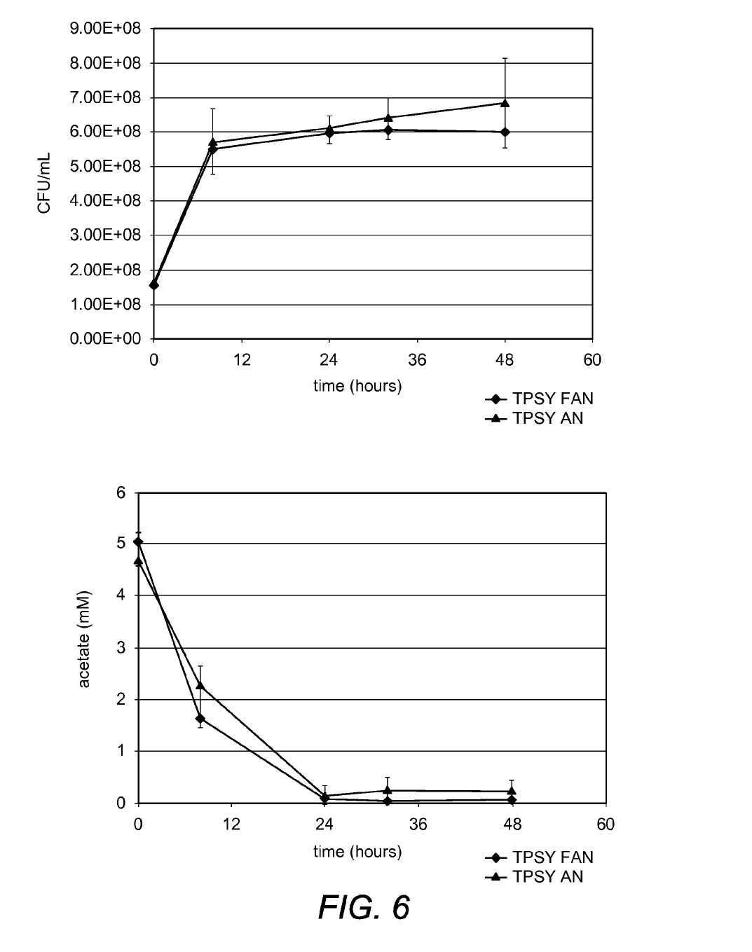

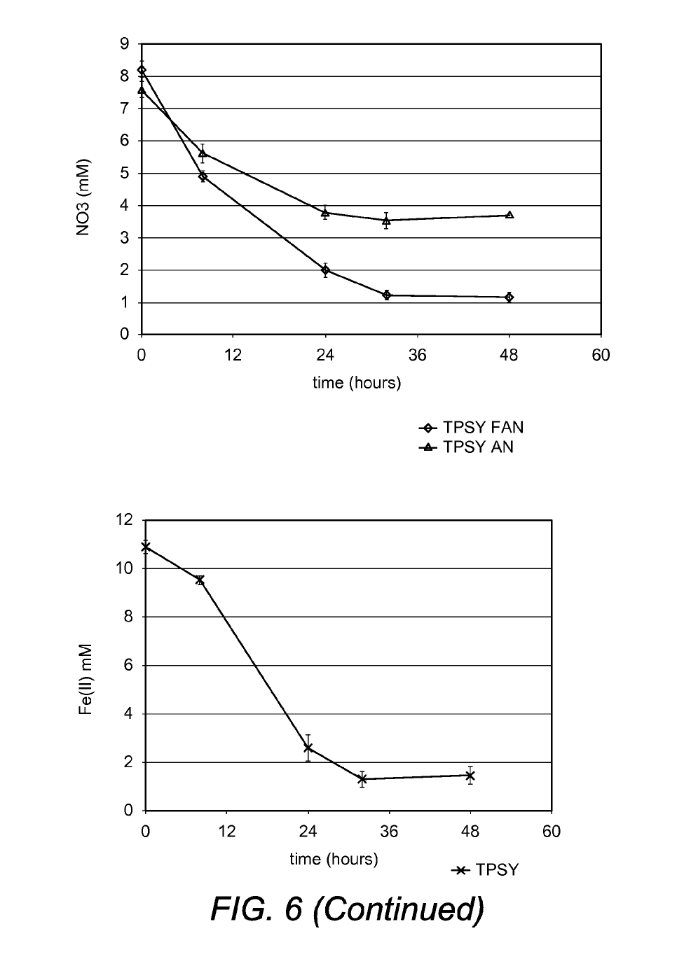

The Diaphorobacter sp. TPSY strain is a member of the beta subclass of Proteobacteria, closely related to Diaphorobacter nitroreducens in the family Comamonadaceae. Moreover, the Diaphorobacter sp. TPSY strain represents the first example of an anaerobic Fe(II)-oxidizer from this family. This organism was shown to grow mixotrophically with Fe(II) as the electron donor, acetate (0.1 mM) as a carbon source and nitrate as the sole electron acceptor (FIG. 6).

The Pseudogulbenkiania sp. strain 2002 is a member of the recently described genus, Pseudogulbenkiania, in the beta class of Proteobacteria¹⁴. Its closest fully characterized relative is Chromobacterium violaceum, a known HCN-producing pathogen. In contrast to C. violaceum, Pseudogulbenkiania str. 2002 is non-fermentative and does not produce free cyanide (CN⁻) or the purple/violet pigments indicative of violacein production, a characteristic of Chromobacterium species. Although when tested, C. violaceum was able to oxidize Fe(II) coupled to incomplete nitrate reduction (nitrate to nitrite), but was not able to grow by this metabolism⁹.

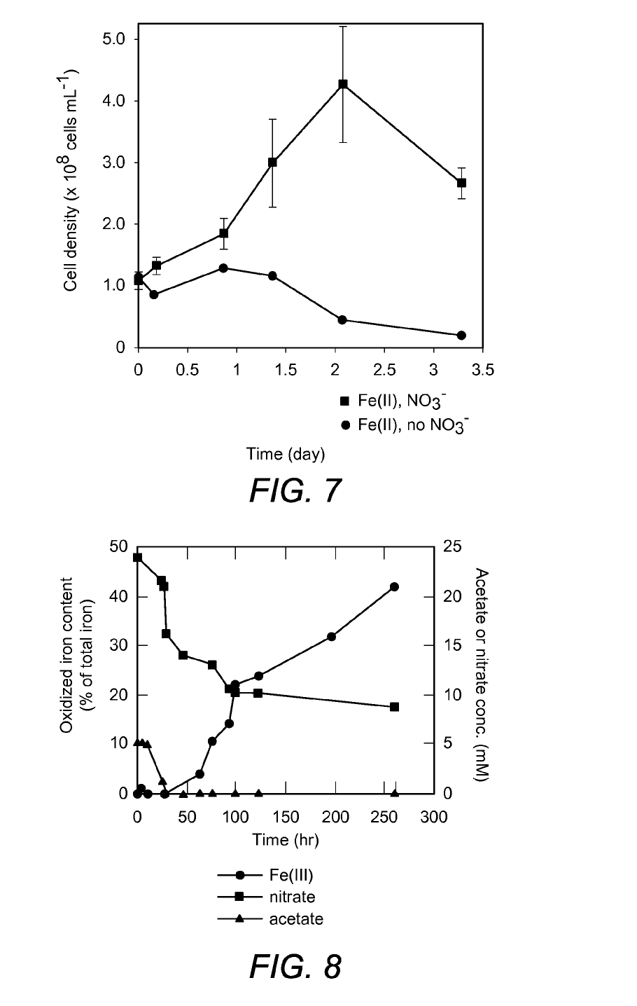

In contrast, Pseudogulbenkiania str. 2002 was shown to readily grow by nitrate-dependent Fe(II) oxidation (FIG. 7). Furthermore, in addition to its ability to grow mixotrophically on Fe(II) with acetate as a carbon source, Pseudogulbenkiania str. 2002 was also capable of lithoautotrophic growth on Fe(II) with CO₂ as the sole carbon source (FIG. 7)⁹.

Cells of Pseudogulbenkiania str. 2002 grown anaerobically on acetate (10 mM) and nitrate (10 mM) were harvested by centrifugation (6,000 g, 10 min), washed twice with anaerobic (100% N2 atmosphere) PIPES [piperazine-N,N′-bis(2-ethanesulfonic acid)] buffer (10 mM, pH 7.0), and resuspended to serve as an inoculum for nongrowth experiments. A washed-cell suspension of C. violaceum was prepared with cells grown anaerobically (100% N₂ atmosphere) on nutrient broth, glucose (10 mM), and nitrate (5 mM).

The prepared washed-cell suspensions (strain 2002 or C. violaceum) were added to anaerobic PIPES (10 mM, pH 7.0) buffer amended with Fe(II) (10 mM) as the sole electron donor and nitrate (4 mM or 2.5 mM) or nitrite (2.5 mM) as the electron acceptor. Heat-killed controls were prepared by pasteurizing (80° C., 10 min) the inoculum in a hot water bath. All cell suspension incubations were performed at 30° C. in the dark, and samples were collected to monitor concentrations of Fe(II), nitrate, and nitrite.

Growth of Pseudogulbenkiania str. 2002 under nitrate-dependent Fe(II)-oxidizing conditions was verified in freshwater basal medium containing 10 mM Fe(II) and 2.2 mM nitrate with or without amendment with 0.1 mM acetate. Freshwater basal medium containing 2.2 mM nitrate without an Fe(II) source served as the negative control. Strain 2002 inoculum was grown under heterotrophic nitrate reducing conditions in medium stoichiometrically balanced for nitrate (10 mM) and acetate (6.25 mM) in order to eliminate the transfer of reducing equivalents [Fe(II)] into the negative control.

The carbon compound required for growth of Pseudogulbenkiania str. 2002 under nitrate-dependent Fe(II)-oxidizing conditions was determined by inoculating an anaerobic, CO₂-free (100% N₂ atmosphere), PIPES-buffered (20 mM, pH 7.0) culture medium containing 1 mM Fe(II)-nitrilotriacetic acid (NTA) and 0.25 mM nitrate with or without a carbon source amendment (1.0 mM HCO3⁻ or 0.5 mM acetate). Strain 2002 was grown as described above in anaerobic, PIPES-buffered culture medium. The headspace of the inoculum was aseptically sparged for 15 min with 100% N₂ to eliminate CO₂ prior to the initiation of the experiment.

The ability of Pseudogulbenkiania str. 2002 to assimilate CO₂ into biomass was verified by amending the nitrate-dependent Fe(II)-oxidizing growth culture medium (basal freshwater PIPES-buffered medium, 5 mM FeCl₂, 2 mM nitrate, 1 mM bicarbonate; 100% He atmosphere) with H¹⁴CO₃⁻ (final concentration, 1 μmol). Rhodospirillum rubrum grown photolithoautotrophically under an anoxic atmosphere (50:50 He:H₂ atmosphere), served as a positive control culture. Triplicate cultures were incubated statically in the dark for 60 h. A subsample (5 ml) was concentrated to a final volume of 0.5 ml by centrifugation (6,000 g, 10 min). A cell extract was prepared from the concentrated sample by three 30 sec pulses in a bead beater (Mini-Bead-Beater-8; Biospec Products, Bartlesville, Okla.) with 0.1-mm silica beads (Lysing Matrix B, Qbiogene product no. 6911-100). The lysate was chilled in an ice bath for 1 min following each pulse. The sample was then centrifuged (10,000 g, 10 min) to remove insoluble cell debris, and the soluble cell extract was withdrawn in order to determine the protein concentration and the ¹⁴C-labeled content.

Replacement of the N₂ in the headspace of Fe(II) oxidizing cultures with He did not enhance cell yield. Normalizing change in cell yield per electron transferred, indicated that the cell yield for autotrophic growth (1.45×10⁻¹¹ cells mL⁻¹ per electron transferred) was approximately 63% that of mixotrophic (Fe(II)-oxidizing with 0.25 mM acetate as carbon source) growth (2.3×10⁻¹¹ cells mL¹ per electron transferred)⁹. To date, autotrophic growth under nitrate-dependent Fe(II)-oxidizing conditions has only been demonstrated in one other organism; a hyperthermophilic archaeon, Ferroglobus placidus¹¹. As such, Pseudogulbenkiania str. 2002 is the first freshwater mesophilic autotrophic nitrate-dependent Fe(II)-oxidizer described in pure culture.

A. suillum readily oxidized (10 mM) Fe(II) in the form of FeCl₂ with nitrate as the electron acceptor under strict anaerobic conditions (FIG. 8). With 10 mM acetate as a cosubstrate, more than 70% of the added iron was oxidized within 7 days. No Fe(II) was oxidized in the absence of cells or if the nitrate was omitted (data not shown). Fe(II) oxidation was initiated after complete mineralization of acetate to CO₂, and growth was not associated with this metabolism. Nitrate reduction was concomitant with Fe(II) oxidation throughout the incubation, and the oxidation of 4.2 mM Fe(II) resulted in the reduction of 0.8 mM nitrate, which is 95% of the theoretical stoichiometry of nitrate reduction coupled to Fe(II) oxidation according to the equation.

While A. suillum readily oxidized Fe(II) in anoxic growth cultures with nitrate as the electron acceptor and Fe(II) as the sole electron donor, no cell density increase was observed throughout the incubation indicating that the organisms did not grow by this metabolism^{5, 6}. When acetate was added as an additional carbon and energy source, cell density increased concomitant with acetate oxidation. Fe(II) oxidation occurred after acetate had been depleted and the culture had reached stationary phase (FIG. 8). Nitrate reduction was concomitant with Fe(II) oxidation throughout the incubation (FIG. 8), and the oxidation of 4.2 mM Fe(II) resulted in the reduction of 0.8 mM nitrate, which is 95% of the theoretical stoichiometry of nitrate reduction coupled to Fe(II) oxidation according to Formula (I):

10Fe²⁺+12H⁺+2NO₃⁻→10Fe³⁺+N₂+6H₂O

Although perchlorate and chlorate are not considered naturally abundant compounds, their potential to serve as electron acceptors in environmental systems cannot be discounted¹⁵. Furthermore, recent evidence suggests that natural perchlorate may be far more prevalent than was first considered, given its recent discovery on Mars. Moreover, the discharge of perchlorate into natural waters has led to widespread anthropogenic contamination throughout the United States¹⁵. Given the ubiquity of perchlorate-reducing bacteria⁸¹ and the ability of these microorganisms, especially the environmentally dominant Azospira sp. and Dechloromonas sp.¹⁶, to oxidize Fe(II), anaerobic (per)chlorate-dependent Fe(II) oxidation may impact iron biogeochemical cycling in environments exposed to contaminated waters.

### Example 2

### Microbial Precipitates of Authigenic Iron Oxides in a Sand-Packed Column Scavenge Sulfides from Column Influents and Reduce Sulfide Content in Column Effluents

Sand-packed column experiments are performed in the laboratory to demonstrate that authigenic minerals can be precipitated by microorganisms in a solid matrix and subsequently used to scavenge sulfides from fluids passing through the column matrix and thereby lower the sulfide contents in column effluents.

The experiment is conducted in two stages. First, an anaerobic Fe(II)-oxidizing bacterium (e.g., Azospira suillum strain PS or Pseudogulbenkiania sp. strain 2002) is incubated with the solid matrix of a sand-packed column in the presence of an authigenic mineral precursor solution (e.g., a FeCl₂ solution) and an authigenic mineral precipitation inducer (e.g., a NO₃⁻ solution). The presence of authigenic iron oxide precipitates in the sand matrix is then confirmed. In the second stage, a sulfide containing solution is passed through the sand-packed column containing the iron oxide precipitates. The sulfide contents of both column influents and effluents are sampled over time. Control experiments are conducted in parallel that use sand-packed columns containing no iron oxide precipitates.

It is expected that the effluent sulfide contents of sand-packed test columns containing iron oxide precipitates are reduced relative to the effluent sulfide contents of control columns. However, if the experiments are conducted under conditions saturating the sulfide-scavenging capacity of iron oxide precipitates, it is expected that the sulfide contents in test column effluents are reduced only temporarily and return to influent sulfide levels once the sulfide-scavenging capacity of the iron precipitates is exhausted.

### Experimental Design

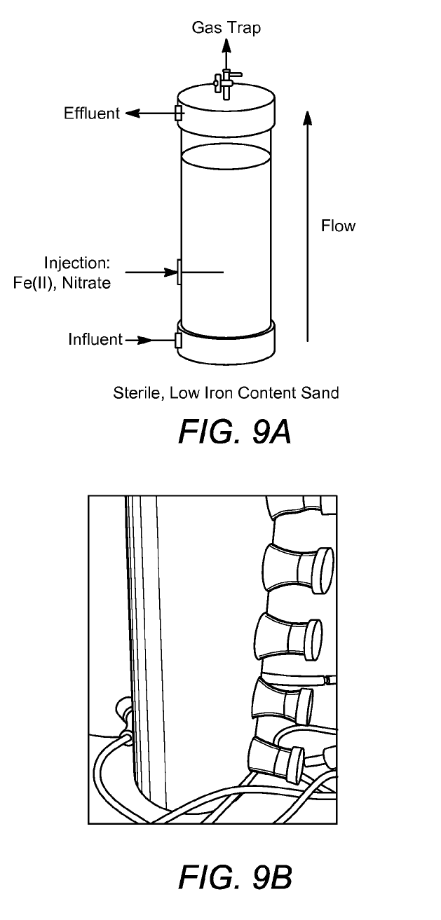

FIG. 9 shows the general design of a sand-packed column. Upflow glass column reactors are constructed and filled with a matrix containing 1N HCl-washed, autoclaved sand inoculated 10% w/w by manual mixing with marine sediment (˜750 mL total matrix volume/column). Columns are sparged with He, sealed with rubber stoppers, and covered with aluminum foil. Columns are incubated for 2 days with approximately 370 mL of seawater containing 2 g/L yeast extract to allow for microbial sulfate reduction to occur. Once active sulfate reduction is ongoing, the columns will be continually injected with seawater containing 2 g/L yeast extract with a hydraulic residence time of 48 hours over 20 days. After 20 days incubation and continual sulfide production in the effluent, the flow will be reversed for 12 hours and the columns will be amended with seawater containing 10 mM nitrate and 25 mM FeCl₂ through the top. The column flow will be suspended for 72 hours before flow is again reverted back to an upflow regime and the columns will be continually injected with seawater containing 2 g/L yeast extract. The effluent sulfide will be monitored in the treated columns both before and after treatment and the results will be compared to columns unamended with FeCl₂.

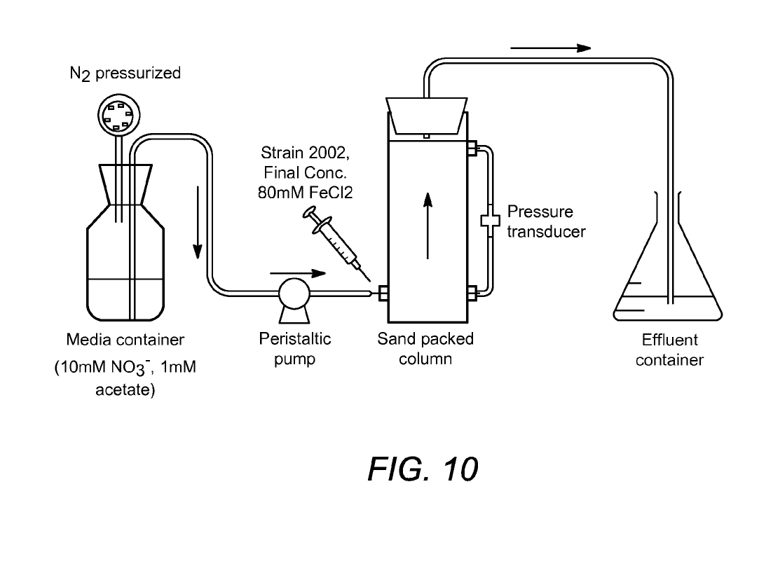

FIG. 10 shows the setup of a flow-through experiment allowing for the cultivation of an anaerobic Fe(II)-oxidizing bacterium in a sand-packed column and the subsequent stimulation of authigenic mineral precipitation in the sand matrix. Basic column specifications typically provide for a porosity of the sand bed of 49%, a permeability of the sand bed of 620 mD, a media flow rate through the column of 0.2 mL/min, an approximate residence time of 47 h, an approximate pressure differential of 0.05 psi, and a particle size of 50-70 mesh. Standard anaerobic techniques are used throughout the study. Anoxic media (pH 6.8) are prepared by boiling the medium to remove dissolved O₂ before they are dispensed under an N₂—CO₂ (80:20, vol/vol) gas phase into anaerobic pressure tubes or serum bottles that are sealed with thick butyl rubber stoppers. The sand-pack flow-through system is kept under positive N₂-pressure at all times (FIG. 10).

### Stage 1: Precipitation of Authigenic Iron Oxide in Sand Matrix

First, the sand-packed column is equilibrated under anoxic conditions in bacterial growth media containing 1 mM acetate and 10 mM NO₃⁻. At the same time, the anaerobic Fe(II)-oxidizing bacterium Pseudogulbenkiania sp. strain 2002 (“strain 2002”) is grown and maintained in suspension cultures as described in Example 4. Generally, bacteria are grown anaerobically in 500-ml volumes of medium with acetate (1 mM) as the sole electron donor and nitrate (10 mM) as the sole electron acceptor. After dense growth of strain 2002, cells are harvested by centrifugation at 4° C. under an N₂—CO₂ headspace. The cell pellets are washed twice and resuspended in 1 ml of anoxic bicarbonate buffer (2.5 g/l, pH 6.8) containing 80 mM FeCl₂. The resuspended bacterial cells are then injected into the sand-packed column as shown in FIG. 10. Using a 10% by volume inoculum size containing ˜10⁹ cells per mL.

The bacteria colonize the sand matrix in the column or will be retained by the matrix such that their dwell time in the matrix is much longer than the dwell time of the mobile bacterial growth medium passing through the matrix Strain 2002 is incubated in the sand-packed column for up to 1 week to allow for authigenic iron oxide precipitation into the sand matrix.

To optimize iron oxide precipitation conditions, preliminary experiments are conducted, wherein samples of the column's sand matrix are taken at regular intervals and the presence of precipitated iron oxide is confirmed and quantified by means of an X-ray diffraction (XRD) analysis of biogenic precipitants, ⁵⁷Fe Mössbauer spectroscopy, or a determination of total Fe content using a standard ferrozine assay. Alternatively, a standard ferrozine colorimetric assay will be conducted measuring the iron content in column effluents. As the bacterial cells are loaded onto the column and incubated with column materials, samples of column effluents are taken and tested for the presence of strain 2002 cells, using either colony formation assays or OD₆₀₀ measurements.

Control experiments are conducted to confirm the microbial origin of authigenic iron precipitates. These control experiments involve either the use of heat inactivated bacteria or test for chemical iron oxide precipitation occurring in the absence of bacterial cells.

### Stage 2: Sulfide Scavenging by Precipitated Iron Oxides

Once the precipitation of authigenic iron oxides in the sand-packed column has been confirmed, the column is equilibrated in a buffer, such as a slightly alkaline Tris-buffered salt solution, that is devoid of electron acceptor components, such as NO₃⁻, and that mimics the alkaline environment of a production well environment (approximately pH 10).

Next, the equilibration buffer is replaced with a sulfide buffer consisting of the equilibration buffer plus sulfide ions, e.g., HS⁻ or S²⁻, at concentrations ranging from 1 μM to 1 mM (e.g., in FIG. 10 the “Media container” is replaced with a container holding sulfide buffer, i.e. the column influent). Thereafter the continuous sampling of column effluents is initiated. The sulfide contents in the effluent samples are then determined using standard colorimetric assays using, e.g., methylene blue. Finally, the sulfide contents of column effluents are compared to the sulfide content in column influents. These measurements are typically continued at least until sulfide can be detected in column effluents and the sulfide concentrations are starting to increase. Often the measurements are continued further, i.e. until the sulfide contents of column effluents correspond approximately to the sulfide content of the column influent.

Control experiments are performed, wherein the sulfide buffer is passed over unmodified sand-packed columns of equal volume that do not contain authigenic iron oxide precipitates.

### Example 3

### Microbial Precipitates of Authigenic Iron Oxides in the Production Well Environment of an Oil Field Scavenge Sulfides from Production Fluids

Experiments are performed in an oil field to demonstrate that authigenic iron oxides can be precipitated in the rock matrix of an oil field's production well environment, that the precipitated iron oxides can scavenge sulfides from the oil in the production well environment, and that the sulfide content in oil produced at the production well is reduced following the authigenic precipitation of iron oxides in the production well environment.

The experiments are performed in at least two stages. First, the production well environment will be incubated with an authigenic mineral precursor solution (e.g., a FeCl₂ solution) and an authigenic mineral precipitation inducer (e.g., a NO₃⁻ solution). In the second stage, oil is produced at the production well. The sulfide content of the produced oil is continuously sampled from the time prior to the first stage and throughout the second stage of the experiment.

### Stage 1: Authigenic Precipitation of Iron Oxide in Production Well Environment

Stage 1 of the experiment is conducted at a time when no oil is being produced at the production well. Instead, during stage 1 of the experiment, authigenic mineral precursor and precipitation inducer solutions are injected into the production well environment, and the greater oil field, though the production well, i.e. by reversing the ordinary flow of fluids through the production well (see, e.g., FIGS. 1A and 1B; note especially injection of Fe(II), NO₃⁻ at the production shown in FIG. 1B). Depending on the size of the oil field, the size and design of the production well, the geology of the rock matrix, applicable flow rates and reagent concentrations, the time of injection of the precursor and inducer solutions may range from hours to days. Moreover, depending on the nature and reactivity of the precursor and inducer reagents used, the respective reagents may be injected either as a premixed solution or separately. In the latter case, the precursor solution is typically injected first. Again, depending on the nature and reactivity of the precursor and inducer reagent used, and interim incubation and dissipation time may be allowed for between the injection of the precursor solution and the precipitation inducer. This dissipation time period may range from a few hours to several days. Without wishing to be bound by theory, this interim time period allows the precursor solution to more fully penetrate the rock matrix before the presence of the inducer triggers precipitation of the authigenic rock minerals.

The experimental design provides for an additional incubation period after completion of stage 1 and prior to initiation of stage 2. Without wishing to be bound by theory, this incubation period is intended to allow sufficient time for the optimal precipitation of authigenic rock minerals in the production well environment.

Stage 2: Production of Oil from Sulfidogenic Reservoir and Confirmation of Microbial Activity and Reduced Sulfide Content

During stage 2 of the experiment oil production from the production well is resumed. The sulfide content of the produced oil is first tested prior to initiation of stage 1 of the experiment and is continuously sampled during the execution of stage 2 of the experiment, e.g., by using traditional methylene blue assays. If reduced sulfide contents are found in production fluids after completion of stage 1, the sulfide contents are continuously monitored until the sulfide levels in production fluids start to rise again and approach levels observed prior to initiation of stage 1. The production volume of fluids with lowered sulfide concentrations is noted.

Further sampling is conducted to confirm the presence of authigenic iron oxide precipitates in the rock matrix of the production well environment. One possible way to confirm the presence of iron oxide precipitate is to analyze sediment materials, such as oil sands, that are by-products of the oil recovery process and contain particles washed out from the rock matrix of the production well environment. Where possible, rock materials from the production well environment are cored and analyzed for iron minerals using X-ray diffraction or equivalent methods. Subsequently, results are compared to corresponding analyses conducted on rock materials that were recovered during the initial insertion of the production well.

The presence of authigenic rock mineral precipitating bacteria in the production well environment is confirmed through sampling of sediments produced at the production well or sampling of the production well's rock matrix. In at least some experiments, combinations of authigenic mineral precipitation inducers and precursor solutions are used that do not effectively induce the (chemical) precipitation of authigenic rock minerals in the absence of mineral precipitating bacteria (e.g., NO₃⁻ and Fe(II)). In some variations of the described experiment authigenic mineral precipitating bacteria are further added to the production well environment. These added bacteria are grown and cultured in the laboratory or an industrial-scale fermentation facility. Bacterial suspensions are added to the reservoir prior to initiation of stage 1 through injection through the production well environment.

### Example 4

### Microbial Solid-Phase Fe(II) Oxidation Creates Sulfide Scavenging Surfaces and can Modulate Rock Surfaces for Improved Deposition of Authigenic Rock Minerals

This example illustrates a biological rock weathering strategy for changing the rock geology in the production well environment. Biological weathering can be used to enhance the rock matrix's sulfide scavenging capacity and to increase the surface areas of rock matrices available for the deposition of authigenic rock materials.

Solid phase Fe(II), including surface-bound Fe(II)^{7, 8}, crystalline Fe(II) minerals (siderite, magnetite, pyrite, arsenopyrite and chromite)^{5, 7}, and structural Fe(II) in nesosilicate (almandine and staurolite)⁵ and phyllosilicate (nontronite)¹³, are known to be subject to direct nitrate-dependent microbial oxidation. For example, washed anaerobic whole-cell suspensions of A. suillum were found to rapidly oxidize the Fe(II) content in various natural iron minerals, including the silicaceous minerals almandine and staurolite⁵ (Table 1).

Both the rate and extent of Fe(II) oxidation was different for the various minerals, which is believed to be due to differences in bioavailability of the Fe(II) in the mineral matrices. No oxidation of Fe(II) was observed in abiotic controls or in the absence of a suitable electron acceptor.

TABLE 1
Microbial oxidation of Fe(II) present in different natural
iron minerals by anoxic washed whole-cell suspensions of
A. suillum coupled to the reduction of nitrate

| | | Fe(II) oxidized | |
|---|---|---|---|
| | | mmol | percent of |
| Mineral | Chemical Formula | kg⁻¹ | total Fe(II) |
| Almandine | Fe₃Al₂(SiO₄)₃ | 10.32 | 52.00 |
| Arsenopyrite | FeAsS | 18.27 | 31.00 |
| Chromite | FeCr₂O₄ | 9.42 | 95.00 |
| Siderite | FeCO₃ | 288.91 | 30.42 |
| Staurolite | (Fe,Mg,Zn)₂Al₉(Si,Al)₄O₂₂(OH)₂ | 0.96 | 16.67 |

Based on these results, it is possible to change the rock geology in the production well environment of a sulfidogenic reservoir by promoting the nitrate-dependent microbial oxidation of Fe(II) minerals in rock matrices. Resulting Fe(III) ions on matrix surfaces are available for sulfide scavenging. Additionally, the partial microbial oxidation of rock matrices can increase the rock matrix porosity and surface area available for the subsequent deposition of authigenic rock materials and sulfide scavengers.

### Example 5

### Dechloromarinus Strain NSS can Control Reservoir Souring by Oxidizing Sulfide to Elemental Sulfur

The previously discussed methods for immediate souring control in production fluids from sulfidogenic reservoir systems may be combined with other methods for controlling souring in these reservoirs. This example illustrates the ability of a (Dissimilatory) (Per)chlorate-Reducing Bacterium (DPRB), Dechloromarinus strain NSS, to oxidize sulfide to elemental sulfur. This microbial activity is useful to control souring especially at the injection well of sulfidogenic reservoir systems (see also, FIGS. 1A and 1B).

A chlorate-reducing organism Dechloromarinus strain NSS was isolated from hydrocarbon-contaminated harbor sediments collected from the Naval Station San Diego Bay, Calif. Strain NSS grew optimally at 30° C., pH 7.5, in 4% NaCl (mass per volume) salinity. However, growth was observed at up to 40° C. and a salinity of 10% NaCl (mass per volume). Phenotypic characterization revealed that in addition to chlorate, which was completely reduced to chloride, strain NSS could alternatively grow anaerobically with nitrate. Strain NSS could utilize a range of simple organic acids and alcohols as alternative electron donors. In addition, Dechloromarinus strain NSS also utilized Fe (II) or H₂S coupled to the reduction of chlorate.

### Oxidation of Sulfide to Elemental Sulfur

Cells of Dechloromarinus strain NSS were grown anaerobically in 1000 mL of medium containing acetate as the electron donor and chlorate as the electron acceptor. After the desired growth (i.e., mid log phase), the cells were harvested by centrifugation and washed with anoxic bicarbonate buffer (2.5 g/L) under a headspace of N₂—CO₂ (80:20; v/v). The washed cells were then resuspended in 1 mL anoxic bicarbonate buffer and sealed in a 10 mL serum vial with a thick butyl rubber stopper under a headspace of N₂—CO₂ and were used for experiments. For the experiments, the cells were treated with: 1) Na₂S at a final concentration of 10 mM; 2) NaClO₃ at a final concentration of 10 mM; or 3) Na₂S and NaClO₃, both supplied at a final concentration of 10 mM. The cells were incubated with each treatment for a period of several weeks.

Heat-killed cells were prepared by placing a portion of the cell suspension in boiling water for 5 min and then cooling the cells. The presence of chlorate, chloride, nitrate, nitrite, sulfate, and sulfite were determined using a Dionex DX500 ion chromatograph (Dionex Corporation, Sunnyvale, Calif.) equipped with a GP50 gradient pump, CD20 conductivity detector, ASRS-Ultra for suppressed conductivity, and PeakNet 6 controlling software. An IonPac AS9-SC 4×250 mm column was used for analysis with bicarbonate buffer containing 2 mM sodium carbonate and 0.75 mM sodium bicarbonate at a flow rate of 2 (mL min-1) as the eluent. The SRS current was set at 100 mA for all the analysis.

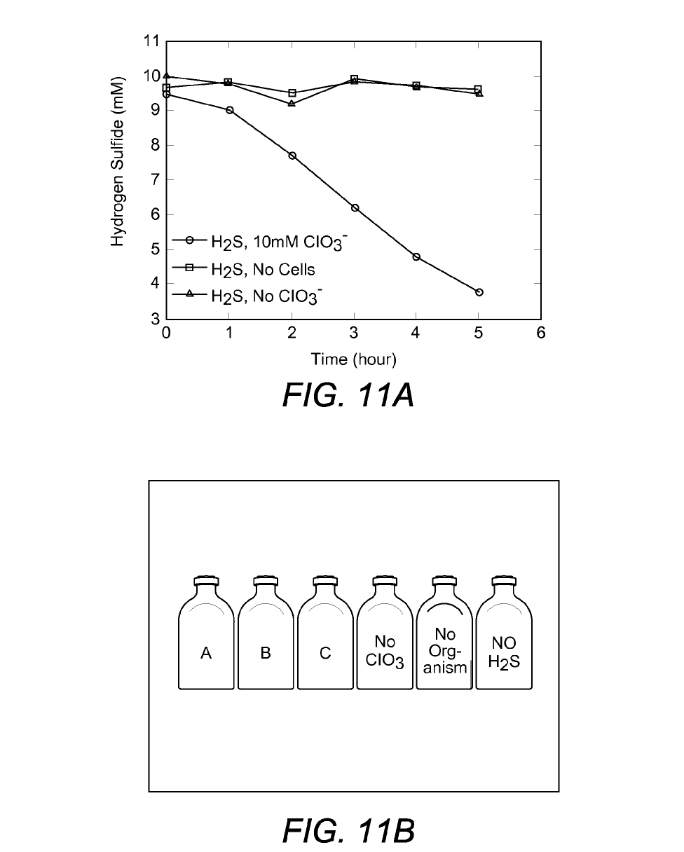

As shown in FIG. 11, the sulfide was oxidized to elemental sulfur, which precipitated out of solution. Furthermore, no sulfur oxyanions (e.g., sulfate, sulfite, etc.) were observed even after extended incubations.

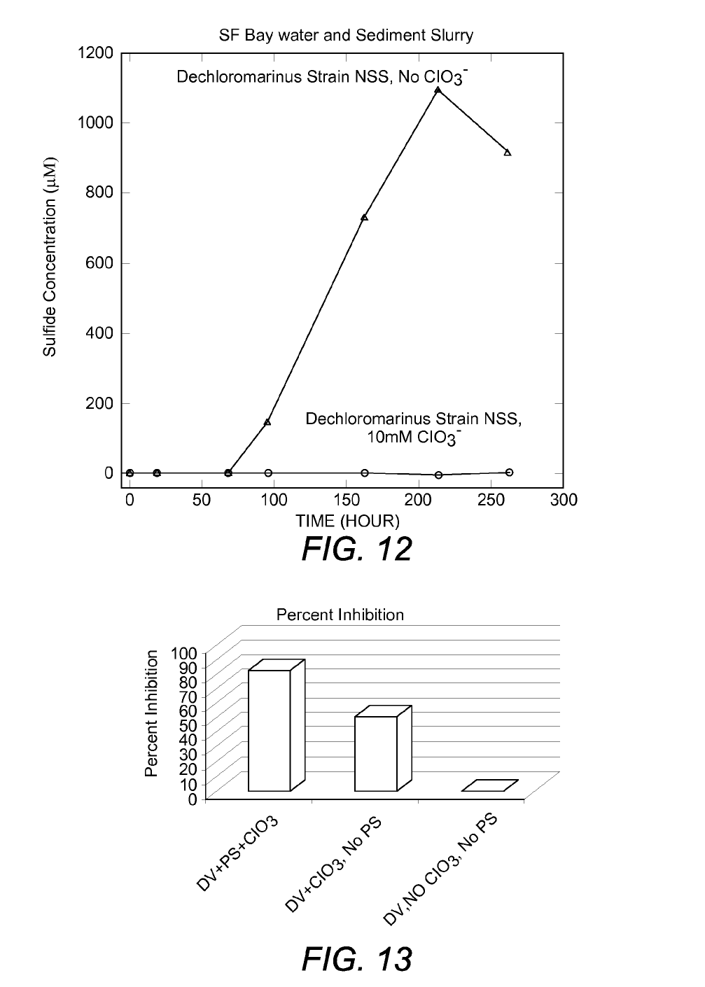

FIG. 12 shows sulfide inhibition in marine sediment slurry microcosms after extended incubation for over 250 hours after addition of chlorate and Dechloromarinus strain NSS. In the absence of chlorate and Dechloromarinus strain NSS sulfide is readily produced.

### Example 6

### Inhibition of Sulfate-Reducing Bacteria (SRB) can Control Reservoir Souring by Inhibiting Sulfide Production

The previously discussed methods for immediate souring control in production fluids from sulfidogenic reservoir systems may be combined with other methods for controlling souring in these reservoirs. This example illustrates the inhibitory effect of (per)chlorates on sulfide-reducing bacteria. This microbial activity is useful to control souring especially at the injection well of sulfidogenic reservoir systems (see also, FIGS. 1A and 1B).

To demonstrate the inhibition of microbial sulfate reduction, active cells of the sulfate reducing species Desulfovibrio vulgaris were incubated with the (per)chlorate reducing species Azospira suillum. Twelve tubes of basal anaerobic medium containing 15 mM lactate and 15 mM sulfate were inoculated with an active culture of D. vulgaris and incubated for 6 hours at 30° C., until a visible increase in optical density was observed. After six hours, the tubes were further inoculated with A. suillum and 15 mM chlorate prior to incubation overnight at 30° C., as outlined in Table 2.

TABLE 2
Experimental tube treatment

| Tube Number | D. vulgaris | A. suillum | Chlorate |
|---|---|---|---|
| 1-3 | Yes | Yes | Yes |
| 4-6 | Yes | No | Yes |
| 6-10 | Yes | No | No |
| 11-12 | No | Yes | Yes |

The results indicated that sulfate reduction to sulfide was significantly inhibited when lactate was used as the electron donor. Additionally, after the 24-hour incubation with A. suillum and 15 mM chlorate, sulfide production by D. vulgaris was only 17% of the sulfide production seen in the control cells incubated in the absence of A. suillum and 15 mM chlorate (FIG. 13). It was also observed that thick cell growth was still apparent in the culture tubes of the D. vulgaris cells incubated with A. suillum and 15 mM chlorate.

Moreover, incubation with 15 mM chlorate alone for 24 hours significantly inhibited sulfidogenesis by D. vulgaris, as sulfide production was only 49% of the control cells incubated without chlorate (FIG. 13). This result indicates that chlorate at relatively low concentrations has antimicrobial activity against D. vulgaris.

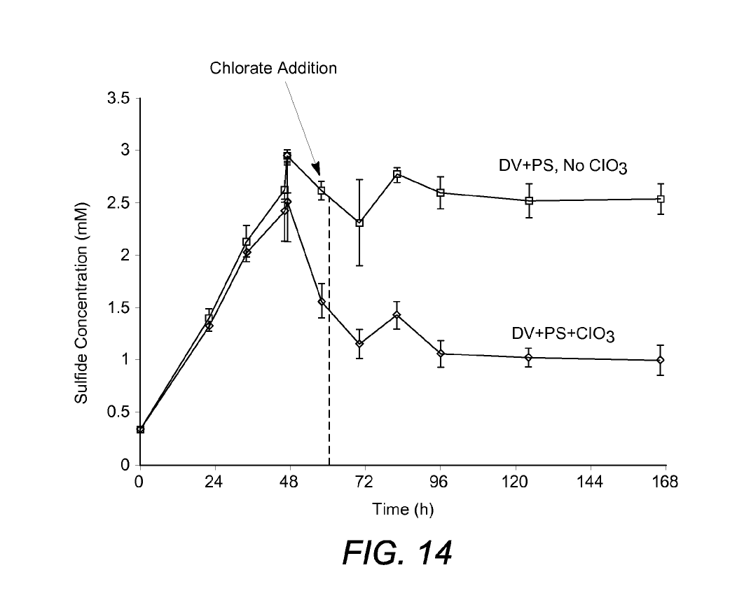

Additionally, FIG. 14 shows a time course showing inhibition of sulfidogenesis by the SRB D. vulgaris (DV) when treated with the (per)chlorate reducing organism A. suillum (PS) and chlorate at 48 hours. As can be seen, the treatment results in immediate inhibition of sulfide production and removal of sulfide from the medium relative to the untreated control which continues to make sulfide.

### REFERENCES

1 Lack, J. G. et al Immobilization of radionuclides and heavy metals through anaerobic bio-oxidation of Fe(II). Appl. Environ. Microbiol. 68, 2704-2710 (2002).
2 Weber, K. A., Achenbach, L. A. & Coates, J. D. Microorganisms pumping iron: anaerobic microbial iron oxidation and reduction. Nat Rev Micro 4, 752-764 (2006).
3 Cornell, R. M. & Schwertmann, U. The iron oxides: Structure, properties, reactions, occurrences and uses. 2 edn, (WILEY-VCH, 2003).
4 Straub, K. L., Benz, M., Schink, B & Widdel, F. Anaerobic, nitrate-dependent microbial oxidation of ferrous iron. Appl. Environ. Microbiol. 62, 1458-1460 (1996).
5 Chaudhuri, S. K., Lack, J. G. & Coates, J. D. Biogenic magnetite formation through anaerobic biooxidation of Fe(II). Appl. Environ. Microbiol. 67, 2844-2848 (2001).
6 Lack, J. G., Chaudhuri, S. K., Chakraborty, R., Achenbach, L. A. & Coates, J. D. Anaerobic biooxidation of Fe(II) by Dechlorosoma suillum. Microb Ecol 43, 424-431 (2002).
7 Weber, K. A., Picardal, F. W. & Roden, E. E. Microbially catalyzed nitrate-dependent oxidation of biogenic solid-phase Fe(II) compounds. Environ. Sci. Technol. 35, 1644-1650 (2001).
8 Weber, K. A., Urrutia, M. M., Churchill, P. F., Kukkadapu, R. K. & Roden, E. E. Anaerobic redox cycling of iron by freshwater sediment microorganisms. Environ. Microbiol. 8, 100-113 (2006).
9 Weber, K. A. et al. Anaerobic nitrate-dependent iron(II) bio-oxidation by a novel, lithoautotrophic, Betaproteobacterium, Strain 2002. Appl. Environ. Microbiol. 72, 686-694 (2006).
10 Weber, K. A., Achenbach, L. A. & Coates, J. D. Microbes Pumping Iron: Anaerobic Microbial Iron Oxidation and Reduction. Nature Rev. Microbiol. (2006).
11 Hafenbradl, D. et al. Ferroglobus placidus gen. nov., sp. nov. a novel hyperthermophilic archaeum that oxidizes Fe²⁺ at neutral pH under anoxic conditions. Arch. Microbiol. 166, 308-314 (1996).
12 Bruce, R. A., Achenbach, L. A. & Coates, J. D. Reduction of (per)chlorate by a novel organism isolated from a paper mill waste. Environ Microbiol 1, 319-331 (1999).
13 Shelobolina, E. S., VanPraagy, C. G. & Lovley, D. R. Use of ferric and ferrous iron containing minerals for respiration by Desulfitobacterium frappieri. Geomicrobiol. J. 20, 143-156 (2003).
14 Weber, K. A. et al. Physiological and taxonomic description of the novel autotrophic, metal oxidizing bacterium, Pseudogulbenkiania sp. strain 2002. Appl. Microbiol Biotechnol. 83, 555-565 (2009).
15 Coates, J. D. & Achenbach, L. A. Microbial perchlorate reduction: Rocket-fuelled metabolism. Nature Rev. Microbiol. 2, 569-580 (2004).
16 Coates, J. D. et al. The ubiquity and diversity of dissimilatory (per)chlorate-reducing bacteria. Applied and Environmental Microbiology 65, 5234-5241 (1999).
17 Ferris, F. G. & Stehmeier, L. G. Bacteriogenic mineral plugging. U.S. Pat. No. 5,143,155 (Sep. 1, 1992).
18 Carlson, H. K., Clark, I. C. & Melnyk R. A., and Coates, J. D. Towards a mechanistic understanding of an anaerobic nitrate-dependent iron oxidation: balancing electron uptake and detoxification. Front. Microbiol. 3, 57 (2012).
19 Reichert, G. Process for removal of hydrogen sulphide using specific iron oxides. U.S. Pat. No. 4,956,160 (Sep. 11, 1990).
20 Turk, B. S., Gangwal, S. K. & Gupta, R. Regenerable sorbents for removal of sulfur from hydrocarbons and processes for their preparation and use. Pub. No. US 2008/0251423 (Oct. 16, 2008).
21 Bailey, R. P., Bennett, T. & Benjamin, M. M. Sorption onto and recovery of Cr(IV) using iron-oxide-coated sand. Wat. Sci. Tech. 26, 1239-1244 (1992).
22 Benjamin, M. M., Sletten, R. S., Bailey, R. P. & Bennett, T. Sorption and filtration of metals using iron-oxide-coated sand. Wat. Res. 30, 2609-2620 (1996).
23 Poulton, S. W., Krom, M. D., Van Rijn, J. & Raiswell, R. The use of hydrous iron (III) oxides for the removal of hydrogen sulphide in aqueous systems. Wat. Res. 36, 825-834 (2002).

1. A method of decreasing one or more sulfide containing compounds in a gas or fluid produced from a sulfidogenic reservoir system, the method comprising:
a) providing a sulfidogenic reservoir system comprising a production well, and a production well environment, wherein the production well environment further comprises authigenic mineral precipitating bacteria, a rock matrix and a gas or fluid;
b) providing an authigenic mineral precursor solution and an authigenic mineral-precipitation inducer; and
c) contacting the production well environment with the authigenic mineral precursor solution and the authigenic mineral-precipitation inducer under conditions whereby the inducer induces the bacteria to precipitate an authigenic mineral from the solution into the rock matrix, wherein the precipitated authigenic mineral scavenges one or more sulfide containing compounds from the gas or fluid in the production well environment,
thereby decreasing the amount of the one or more sulfide-containing compounds in the gas or fluid produced from the sulfidogenic reservoir system.

2. The method of claim 1, further comprising
d) determining the concentration of the one or more sulfide-containing compound before and after execution of step c) thereby quantifying the amount by which the one or more sulfide-containing compound has decreased in the gas or fluid produced from the sulfidogenic reservoir system.

3. The method of claim 1, wherein the authigenic mineral precursor solution is selected from the group consisting of an Fe(III) solution, an Fe(II) solution, an elemental Fe solution, a noble iron nanoparticle solution, an ammonium solution, a phosphate solution, a phosphite solution, a calcium solution, a carbonate solution, and a manganese solution.

4. (canceled)

5. The method of claim 1, wherein the authigenic mineral-precipitation inducer is selected from the group consisting of nitrate, nitrite, nitrous oxide, nitric oxide, perchlorate, chlorate, chlorite, chlorine dioxide, carbonate, phosphite, phosphate, and oxygen.

6. The method of claim 1, wherein the production well environment is concurrently contacted with the authigenic mineral precursor solution and the authigenic mineral precipitation inducer.

7. The method of claim 1, wherein the production well environment is contacted first with the authigenic mineral precursor solution and second with the authigenic mineral precipitation inducer.

8. (canceled)

9. (canceled)

10. (canceled)

11. The method of claim 1, wherein the authigenic mineral is selected from a group consisting of Fe₂O₃, vivianite, siderite, MnO, Mn₃O₄, Mn₂O₃, MnO₂, and Mn₂O₇.

12. (canceled)

13. The method of claim 1, wherein the authigenic mineral-precipitating bacteria are iron-oxidizing bacteria, nitrate-dependent Fe(II)-oxidizing bacteria or perchlorate-reducing bacteria.

14. (canceled)

15. The method of claim 1, wherein the amount of the one or more sulfide-containing compounds in the gas or fluid produced from the sulfidogenic reservoir system is decreased by at least 1%, 10%, 20%, 40%, 60%, 80%, 90%, 95%, or 99% relative to the amount of sulfide-containing compound present in the gas or fluid prior to execution of step c).

16. (canceled)

17. (canceled)

18. (canceled)

19. (canceled)

20. (canceled)

21. The method of claim 1, wherein the production well environment is contacted with the authigenic mineral precursor solution and the authigenic mineral-precipitation inducer under conditions whereby the inducer further induces the precursor to chemically precipitate authigenic rock mineral from the solution into the rock matrix, wherein the precipitated authigenic mineral scavenges one or more sulfide containing compounds from the gas or fluid in the production well environment, thereby further decreasing the amount of the one or more sulfide-containing compounds in the gas or fluid produced from the sulfidogenic reservoir system.

22. (canceled)

23. (canceled)

24. (canceled)

25. (canceled)

26. (canceled)

27. The method of claim 1, wherein the authigenic mineral precipitation is the result of a reversible reaction.

28. The method of claim 27, further comprising:
d) dissolving the precipitated authigenic mineral by reversing the authigenic mineral precipitation reaction, thereby releasing the one or more sulfide-containing compound scavenged by the precipitated authigenic mineral into the gas or fluid in the production well environment;
e) removing the released one or more sulfide-containing compound from the sulfidogenic reservoir along with the gas or fluid in the production well environment; and
f) repeating steps a)-c)
thereby decreasing the amount of the one or more sulfide-containing compounds in the gas or fluid produced from the sulfidogenic reservoir system.

29. (canceled)

30. The method of claim 1, further comprising:
d) the sulfidogenic reservoir system of step a), further comprising one or more sulfate-reducing bacteria; and
e) adding a composition comprising one or more chlorine oxyanions to the system at a concentration sufficient to inhibit sulfate-reducing activity of the sulfate-reducing bacteria,
thereby inhibiting sulfidogenesis and decreasing the amount of the one or more sulfide-containing compounds in the sulfidogenic reservoir system, wherein the one or more chlorine oxyanions are selected from the group consisting of hypochlorite, chlorine dioxide, chlorite, chlorate, perchlorate, and mixtures thereof.

31. The method of claim 1, further comprising:
d) the sulfidogenic reservoir system of step a), further comprising one or more (per)chlorate-reducing bacteria; and
e) adding a composition comprising one or more chlorine oxyanions to the system at a concentration sufficient to stimulate (per)chlorate-reducing activity of the (per)chlorate-reducing bacteria,
thereby inhibiting sulfidogenesis and decreasing the amount of the one or more sulfide-containing compounds in the sulfidogenic reservoir system, wherein the one or more chlorine oxyanions are selected from the group consisting of hypochlorite, chlorine dioxide, chlorite, chlorate, perchlorate, and mixtures thereof.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. The method of claim 1, wherein the sulfidogenic reservoir system is selected from the group consisting of an oil reservoir, a natural gas reservoir, a ground water aquifer, and a CO₂ storage well.

44. The method of claim 1, wherein the method further comprises adding molybdenum to the sulfidogenic reservoir system.

45. (canceled)

46. (canceled)

47. (canceled)

48. (canceled)

49. The method of claim 28, wherein the system further comprises authigenic mineral-dissolving bacteria, and wherein the system is contacted with an authigenic mineral-dissolving inducer under conditions whereby the authigenic mineral-dissolving inducer induces the authigenic mineral-dissolving bacteria to dissolve the precipitated authigenic mineral.

50. (canceled)

51. The method of claim 49, wherein the authigenic mineral-dissolving inducer is selected from the group consisting of phosphite, H₂, formate, ethanol, glucose, acetate, propionate, butyrate, lactate, benzoate, citrate, hexose, hexane, propane, ethane, methane, toluene, phenol.

52. The method of claim 49, wherein the authigenic mineral-dissolving bacteria dissolve the precipitated authigenic mineral by reversing the authigenic mineral precipitation reaction.

53. (canceled)

54. (canceled)

55. The method of claim 49, wherein the authigenic mineral-dissolving bacteria are selected from the group consisting of iron-reducing bacteria, and acid-producing bacteria.

56. (canceled)
